(19) United States
(12) Patent Application Publication
(10) Pub. No.: US 2025/0144548 A1
(43) Pub. Date: May 8, 2025

(54) CONTINUOUS SEPARATION OF MULTIPHASE MIXTURES

(71) Applicant: CZERO, INC., Goleta, CA (US)

(72) Inventors: Samuel SHANER, Goleta, CA (US); Brett PARKINSON, Goleta, CA (US); Andrew CALDWELL, Goleta, CA (US); Ryan PATRICK, Goleta, CA (US); Lucas RUSH, Goleta, CA (US); Eric MCFARLAND, Goleta, CA (US)

(21) Appl. No.: 18/832,606

(22) PCT Filed: Jan. 25, 2023
(86) PCT No.: PCT/US2023/061295

§ 371 Date: Jul. 24, 2024

Related U.S. Application Data
(60) Provisional application No. 63/302,843, filed on Jan. 25, 2022.

(51) Int. Cl. B01D 19/00

(52) U.S. Cl. CPC B01D 19/0057; B01D 19/0005

(57) ABSTRACT

A reaction system includes a vessel having a gas inlet and a gas outlet, a liquid within the vessel, a solid phase and a gas phase present within the vessel, and at least one liquid separator disposed within the vessel. The liquid has an upper liquid surface within the vessel, and the liquid separator is configured to remove at least a portion of liquid droplets generated based on the gas phase and the solid phase passing through the liquid.

### CROSS-REFERENCE TO RELATED APPLICATIONS

This application claims priority to and the benefit of U.S. Provisional Patent Application No. 63/302,843 filed on Jan. 25, 2022 with the United States Patent Office and entitled, “CONTINUOUS SEPARATION OF MULTIPHASE MIXTURES,” which is incorporated by reference herein in its entirety.

### STATEMENT REGARDING GOVERNMENTALLY SPONSORED RESEARCH OR DEVELOPMENT

This invention was made with government support under Grant DE-AR0001194 awarded by the Department of Energy. The government has certain rights in this invention.

### BACKGROUND

In a variety of chemical processes, multiphase mixtures of different chemicals and materials coexist in vessels, and it is desirable to separate the different phases. Two-phase separations are ubiquitous in chemical processing and wastewater treatment and many methods are deployed commercially. However, the separations can become more complicated when additional phases are present.

### SUMMARY

The present invention relates to methods for treating mixtures of gases, liquids, and solids.

In some embodiments, a system comprises a vessel having a gas inlet and a gas outlet, a liquid within the vessel having an upper liquid surface within the vessel, a solid phase and a gas phase present within the vessel, and at least one liquid separator disposed within the vessel. The liquid separator is configured to remove at least a portion of liquid droplets generated based on the gas phase and the solid phase passing through the liquid.

In some embodiments, a process comprises receiving a gas into a vessel containing a liquid, passing bubbles of the gas through the liquid, where a solid is present within the liquid, passing the gas out of an upper liquid surface at a top surface of the liquid, forming droplets of the liquid based on passing the gas out of the upper liquid surface, separating the solid from the liquid at the upper liquid surface, passing the gas and at least a portion of the solids out of the vessel through a gas outlet, and removing at least a portion of the droplets of the liquid before passing the gas and the solid out of the vessel.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIGS. 1A and 1B schematically illustrate the process aspects of the inventions described.

FIG. 2 schematically illustrates the formation of liquid droplets from gas bubbles breaking the surface of a liquid.

FIG. 3 schematically illustrates a bubble column with gas bubbles rising in liquid containing suspended solids with disengagement and separation in cyclone.

FIGS. 4A and 4B schematically illustrate removal of liquid droplets using a perforated plate or mesh onto which droplets deposit, aggregate and return to the melt.

FIG. 5 schematically illustrates removal of liquid droplets using a low gas velocity gas volume on the bubble column surface whereby droplets drop out of suspension and/or impinge on suspended perforated plates or mesh onto which droplets deposit, aggregate and return to the melt.

FIG. 6 schematically illustrates removal of liquid droplets at the top of a bubble column by passing the outlet stream after the liquid surface through a packed column section whereby droplets drop out of the suspension and/or impinge on packing onto which droplets deposit, aggregate and return to the melt.

FIG. 7 schematically illustrates removal of liquid droplets in a suspension leaving a bubble column by passing the suspension through a cyclonic volume.

FIG. 8 schematically illustrates a widened surface area at the top of a liquid bubble column, solid collection and resuspension.

FIG. 9 schematically illustrates structured materials above a bubble column allowing for droplet aggregation or segregation via induced cyclonic action

FIGS. 10A and 10B schematically illustrate reducing the amount of liquid droplets in a suspension leaving a bubble column by adding packing at or near the liquid surface.

FIG. 11 schematically illustrates reducing the amount of liquid droplets in a suspension leaving a packed bubble column by adding additional packing above the liquid surface.

FIGS. 12A and 12B schematically illustrate a cyclone reducing the amount of liquid droplets in a suspension leaving a packed bubble column but allowing suspended solids to pass.

FIGS. 13A and 13B schematically illustrate the bubble coalescence to form slug by generating swirling flow. Bubble coalescence reduces the number of droplet formation due to bubble disengagement.

FIG. 14 schematically illustrates separation using a settling volume with reactor heat integration.

FIG. 15 schematically illustrates separation using a high gas holdup reactor region.

FIGS. 16A and 16B schematically illustrate separation with multiphase liquids and using a mesh.

FIG. 17 schematically illustrates a solid bed on top of a liquid bubble column to eliminate droplets.

FIG. 18 schematically illustrates a solid bed on top of a liquid bubble column to eliminate droplets where solid exits separately from the gas.

FIG. 19 schematically illustrates a tapered solid bed on top of a liquid bubble column to eliminate droplets where solid exits separately from the gas.

FIG. 20 schematically illustrates separation of solids and gases into separate streams within the reactor with bubble lift circulation.

FIG. 21 schematically illustrates separation of solids and gases into separate streams within the reactor.

### DETAILED DESCRIPTION

The following definitions are used herein:
Reactant: Any substance that enters into and is potentially altered in the course of a chemical transformation.
Product: A substance resulting from a set of conditions in a chemical or physical transformation.
Reactor: A container or apparatus in which substances are made to undergo chemical transformations.
Catalyst: A substance that increases the rate of a chemical reaction or enables a chemical reaction to proceed under different conditions than otherwise possible.
Condensed Phase: A liquid and/or solid.
Bubble column: A vertically-arranged, liquid-filled vessel with gas inserted at the bottom.
Film: A thin covering or coating.
Multiphase mixtures of different chemicals and materials coexist in vessels, and it is desirable to separate the different phases. While two-phase separations are common, three-phase separations are less commonly encountered. The present disclosure describes methods and devices for separation of solid and gas phase products from three-phase mixtures of liquids, solids, and gases.

A major challenge of such separations is to efficiently remove large flowrates of the gases and solids traveling through a liquid containing vessel without entraining or discharging any of the liquid media. In systems discharging a gas-solid suspension, it is often unavoidable to entrain liquid as droplets and/or aerosols that are formed at the liquid surface during disengagement resulting in liquid media loss. Solids discharged in separate streams may have residual liquid media adhered to the solid surface in the exiting predominately solid stream; the predominately gas stream may also contain liquid droplets as an aerosol and/or vapor. Some methods and devices addressing the removal of liquid droplets from gas streams or solid particles from gas streams include demisters, cyclones, and filters, though less is known regarding approaches for selective removal and retention of liquids from vessels containing liquids, gasses, and solids. The present disclosure provides methods and devices for disengaging multi-phase mixtures of gases and solids from liquids and producing cither streams containing a solid-gas suspension without retained liquid, or, streams containing predominately solids and predominately gases with particular applicability to high temperature liquids including molten salts and/or molten metals.

There are presently no commercial systems for the separation of high temperature mixtures of solids, gases, and liquids from liquid containing vessels whereby the liquid media is retained in the vessel while the gas and solid phase components are continuously removed. The methods and devices disclosed herein make possible the separation of high temperature three-phase mixtures where gases and solids are in contact with high temperature liquids in a vessel and it is desirable to remove the gas and solid phase components while retaining the liquid phase within the vessel. The disclosed systems and methods make the separate production of gaseous products and solid products from three-phase mixtures in liquid filled vessels possible where the phases are intermixed while the liquid phase is retained in the vessel. Further, some aspects allow for the further removal from the solid stream, adventitious solids from the desirable product stream. This element of the disclosed systems and methods is particularly novel and unique for the application of removing solid or liquid metals from solid carbon.

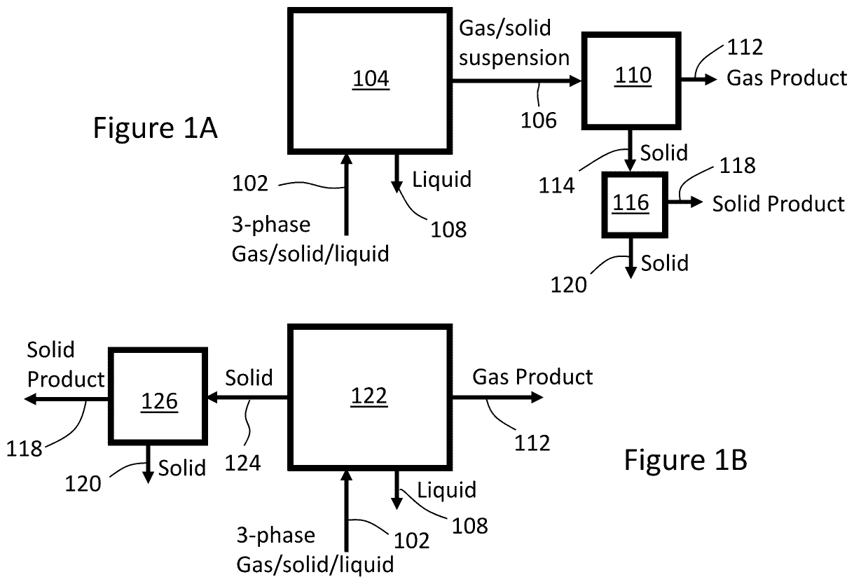

As disclosed herein, the multi-phase separations can be achieved using methods and devices using one of two distinct philosophical approaches for achieving the separations described for a broad range of materials with different phase interactions. Reference is made to FIG. 1. In FIG. 1A, a three-phase mixture 102 enters a separation sub-system 104 whereby the three-phase mixture 102 of liquid-gas-solid is separated into a gas stream 106 with the solid phase material contained in suspension with the liquid 108 remaining and whereby subsequent gas-solid separation 110 is used to ultimately produce gas product 112 and solid product 114 streams. Within the separation sub-system 104 methods and devices are used to ensure the liquid phase is retained. The solid product stream 114 can be further treated in a separation system 116 to further separate components of the solid product stream 114 into a solid product stream 118 and a second solids stream 120.

In FIG. 1B, the three-phase mixture 102 enters a separation sub-system 122 whereby the three-phase mixture 102 is caused to separate into a gas product stream 112 containing predominately the gas-phase components and a separate stream 124 containing predominately the solid-phase components. The liquid 108 can be separated and/or remain within the system. The separate stream 124 can be further treated in a separation system 126 to further separate components of the separate stream 124 into a solid product stream 118 and a second solids stream 120. In some aspects, the solids separation system 116 in FIG. 1A can be the same or similar to the solids separation system 126 in FIG. 1B. From methods and devices implementing one or the other approach streams of solids can be produced and other systems and methods can be used to process the solid stream into a purer solid product stream removing any retained condensed phase contaminants.

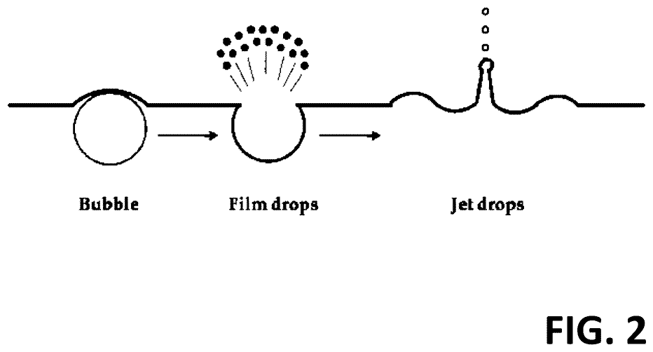

Various systems and methods described herein can be used to produce a liquid-free gas-solid suspension from a three-phase mixture. As used herein, the term “liquid-free” does not require an absolute absence of liquid and rather allows for a reduced amount of liquids relative to the amount of liquids that would be present without the control systems disclosed herein. When gas-solid removal is performed in a solid-liquid suspension and the solid particles are entrained within the gas stream, additional entrainment of the liquid as droplets or aerosols is almost inevitable. Specific aspects of the methods and systems disclosed herein are directed at reducing the liquid content of the gas solid suspension. For illustration, reference is made to FIG. 2 which depicts gas bubbles breaking at a liquid surface and producing droplets of the liquid in the gas phase. Depending on the gas flow rate and properties of the liquid and droplets, the liquid may be entrained with the gas. It is desirable to reduce or minimize the amount of liquid released from the surface and leaving the vessel with the gas and solid phase materials.

For the purposes of this disclosure all liquid present in the gas stream will be referred to as droplets regardless of the size of the liquid particles. The release and entrainment of the droplets can be controlled using an integrated approach of: 1) minimizing the quantity of liquid in the entrained droplets, and/or 2) selective removal of the liquid droplets from the gas-solid stream. The approach consists of several elements: 1) decreased droplet formation by, i) liquid surface stabilization and dampening with novel liquid wettable materials, ii) bubble diversion and redirection, and iii) forced coalescence of the bubbles, and, 2) entrained droplet removal by i) cyclonic flow generation, ii) forced liquid impingement and retention, and iii) centripetal extraction, and/or 3) enhanced solids conveyance through the selection of the conditions to produce a desired solids particle size (e.g., enhanced carbon conveyance by melt selection that promotes the production of finer carbon particle size distributions).

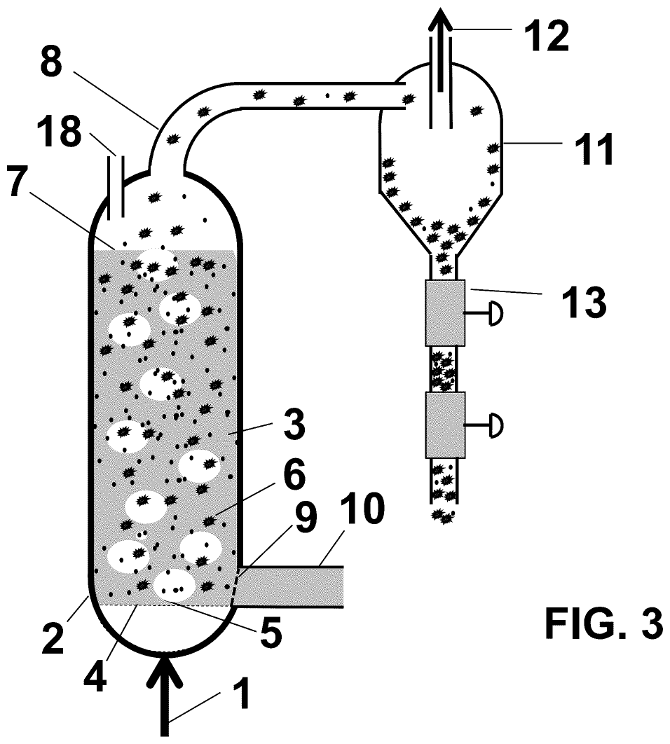

In some aspects such as shown in FIG. 3, a gas stream 1 may be introduced as bubbles 5 into a vessel 2 filled with a liquid 3, which may be a reactor (e.g., a bubble column reactor as shown in FIG. 3). The gas in stream 1 can be introduced through an inlet device 4 such as a perforated plate to create bubbles 5 in the vessel 2. Solids 6 may be introduced into, present, and/or formed in the liquid filled vessel 2. Similar multiphase environments may exist without bubbles such as in liquid trickle beds, falling films, or fluidized bed reactors. In several applications, solids may be present or formed in the liquid such that their relative densities or the action of the bubbles rising to the liquid surface can transport the solids to the liquid surface 7, or another region of the vessel where the products can be removed. In FIG. 3, disengagement of the gas and solid from the liquid occurs at the top of the liquid filled vessel 2, and the gas flowrate can be controlled such that the solid particulates are suspended in the gas flow field and exit the liquid filled vessel 2 through an outlet 8 where a separator 11 such as a cyclone can be used to both separate the solids and gas stream and remove by the centripetal flow field any liquid droplets that may have been co-suspended by contacting the liquid droplets with the cyclone wall.

The vessel and configuration shown in FIG. 3 can comprise any suitable three phase system having gas, liquid, and solids present, and need not comprise a reactor vessel. In some aspects, the vessel can comprise a reactor having a gas, liquid, and solid phase present. For purposes of illustration only, the liquid filled vessel 2 shown in FIG. 3 can comprise a reactor such as a high temperature reactor comprising a liquid such as a molten media (e.g., a molten metal and/or molten salt).

In some aspects, a high temperature reactor can comprise a hydrocarbon pyrolysis reactor. In a pyrolysis reactor, hydrocarbon materials such as natural gas or other molecules or mixtures of molecules containing predominately hydrogen and carbon atoms are transformed into a solid carbon product that can be readily handled and prevented from forming carbon oxides in the atmosphere, as well as a gas phase co-product (e.g., hydrogen, unreacted hydrocarbons, other pyrolysis products, etc.). In some embodiments, the gas-phase co-product, hydrogen, can be used as a fuel or chemical. During methane pyrolysis, carbon is stoichiometrically produced at three times the rate of hydrogen by mass. The overall process in this case can be referred to as pyrolysis, CₙH₂ₘ←mH₂+nC.

In a pyrolysis process, the feed gas (e.g., a hydrocarbon gas) can comprise natural gas (e.g., primarily methane), pure methane, or other hydrocarbon containing compositions containing primarily hydrogen and carbon such as heavier hydrocarbon gases (e.g., ethane, propane, etc.), biomass, hydrocarbon liquids, and the like. In some instances, the hydrocarbon gas can contain elements other than hydrogen and carbon (e.g., oxygen, nitrogen, sulfur, etc.), so long as the other elements are only present in minor amounts.

The molten media can comprise a molten salt, a molten metal, or any combination thereof. In some embodiments, the salts can be any salt having a suitable melting point to allow the molten salt or molten salt mixture to be formed within the reactor. In some embodiments, the salt mixture comprises one or more oxidized atoms (M)+” and corresponding reduced atoms (X)⁻¹, wherein M is at least one of K, Na, Mg, Ca, Mn, Zn, La, Al, or Li, and where X is at least one of F, Cl, Br, I, OH, SO₃, or NO₃. Exemplary salts can include, but are not limited to, NaCl, NaBr, KCl, KBr, LiCl, LiBr, CaCl₂), MgCl₂, CaBr₂, AlCl₃, MgBr₂ and combinations thereof. In some embodiments, the liquid can be or contain a molten metal such as nickel, bismuth, copper, platinum, indium, lead, gallium, iron, palladium, tin, cobalt, tellurium, ruthenium, antimony, gallium, magnesium, calcium, sodium, potassium, oxides thereof, or any combination thereof. For example, combinations of metals having catalytic activity for hydrocarbon pyrolysis can include, but are not limited to: nickel-bismuth, copper-bismuth, platinum-bismuth, nickel-indium, copper-indium, copper-lead, nickel-gallium, copper-gallium, iron-gallium, palladium-gallium, platinum-tin, cobalt-tin, nickel-tellurium, copper-tellurium, combinations thereof, and/or alloys thereof.

Combinations of molten metals and molten salts can also be used. Proper selection of materials can result in two phases being present within the molten media, where the two phases can stratify in some instances. For example, a molten salt can be used with a molten metal as provided herein such that the molten salt can float as a liquid layer on top of the molten metal.

When used as a pyrolysis reactor, the reactor liquid filled vessel 2 can operate at suitable conditions for pyrolysis to occur. In some embodiments, the temperature can be selected to maintain the molten media in the molten state such that the molten media is above the melting point of the composition while being below the boiling point. In some embodiments, the reactor can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. The reactor can operate at any suitable pressure. The reactor may operate at a pressure between about 1 atm and about 25 atm. Higher pressures are possible with an appropriate selection of the reactor configuration, operating conditions, and flow schemes, where the pressure can be selected to maintain a gas phase within the reactor. The resulting reaction can produce carbon as a solid product that can be retained in the liquid phase molten media and be subject to separation along with any unreacted feed gases and product gases using any of the systems described herein.

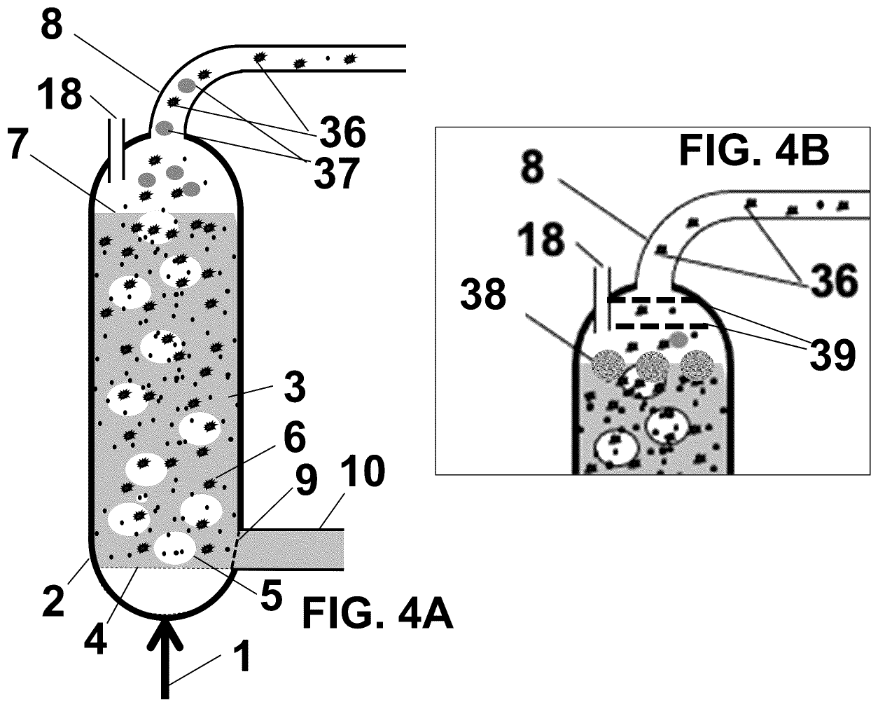

Another embodiment applicable to bubble columns is shown schematically in FIG. 4A, whereby gas I can be introduced into a vessel 2, and gas bubbles 5 can be formed that rise to the surface of the liquid column containing liquid 3 and solid particles 6. At the liquid surface 7, the breaking bubbles allow the gas to leave the vessel 2 with entrained solids 36. In the absence of means for managing liquid droplets 37, droplets produced from the liquid by means of bubbles 5 breaking the liquid surface 7 (e.g., as described in FIG. 2) can also be entrained in the gas stream and transported out of the vessel 2. FIG. 4B schematically illustrates a configuration whereby a layer of individual solids 38 that are lower in density than the liquid, can be placed in the vessel 2 and float on top of the liquid surface. The solids 38 can interrupt the breaking of the bubbles at the surface thereby dampening the surface agitation and reducing the number of droplets 37 generated from the breaking bubbles. The solids 38 can comprise any suitable shape such as spheres, rods, cubes, saddles, rings, etc. and be made of a material suitable to withstand the conditions within the vessel. For example, the solids 38 can comprise metals, ceramics (e.g., zirconia, alumina, ceria, ctc.), spheres of non-reactive materials such as carbon, or the like. The solids 38 can comprise any suitable size, and in some aspects may have diameters of between about 0.01 to about 10 inches, or between about 0.1 to about 1 inch.

As also shown in FIG. 4B, a perforated structure 39 can be placed above the liquid surface and positioned such that the gas and entrained droplets and solids are caused to collide with the structure. The material of the floating solids 38 and structure 39, and/or a coating layer placed on the solids 38 and/or perforated structure 39, can be selected such that the liquid droplets wet the surfaces and remain behind in the vessel resulting in a vessel outlet with less entrained liquids. When additional liquid droplets are deposited on the structure, the liquid can accumulate and drop back into the liquid within the vessel 2. In some aspects, the wetting material can comprise a wetting metal, metal oxide, or ceramic. As used herein, wetting may refer to a material that is wetting with respect to the liquid present in the vessel 2. To modify the gas velocity and direction, additional gas can be added as a gas stream 18 to the top of the vessel 2 to facilitate suspension of the solid particles.

As shown and described with respect to FIGS. 4A and 4B, the use of floating solid materials on the liquid in the vessel and/or the use of one or more perforated structures can help to reduce the amount of entrained liquids leaving with the gas-solid stream leaving the vessel. Accordingly, the use of the floating solids materials and/or perforated structures can be used with any of the other configurations described herein in order to reduce the carryover of liquids with the gas-solid stream.

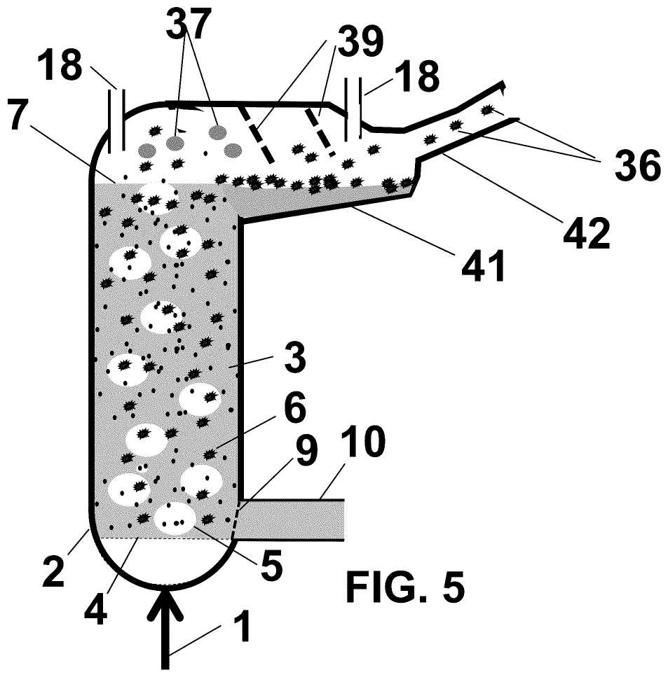

Another embodiment is shown schematically in FIG. 5, whereby gas can be introduced as gas stream 1 into a vessel 2, and gas bubbles 5 can be formed that rise to the surface 7 of the liquid column containing liquid 3 and solid particles 6. The bubble column or vessel 2 can be modified, by having an upper chamber or upper leg 41 at the top to widen the liquid surface area diverting the bubbles breaking at the surface 7 such that droplets formed must traverse the widened top section allowing them to drop out by gravity and/or through contact with perforated structure 39 such as those described with respect to FIG. 4B, where the liquid droplets can wet the structure's surfaces and remain behind the flowing gas-solid suspension resulting in a vessel outlet with less entrained liquids. The cross-sectional flow area at the top of the vessel 2 can be selected to provide a desired gas flow velocity and flow distance to allow for the settling of the droplets. When liquid droplets are deposited on the structure, the liquid can accumulate and drop back into the liquid within the vessel 2. The solids can be driven by the flow of the gas towards the region of the vessel near the exit 42, whereby they would become suspended in the gas flow. To modify the gas velocity and direction, additional gas can be added as a supplemental gas stream 18 at one or more points in the vessel top to facilitate suspension and/or required disengagement residence times.

As shown and described with respect to FIG. 5, the use of an upper leg 41 or section having a widen liquid surface area and/or an increased cross-sectional flow area to the gas flow can help to reduce the amount of entrained liquids leaving with the gas-solid stream leaving the vessel. Accordingly, the use of the upper leg 41 or section having a widen liquid surface area and/or an increased cross-sectional flow area to the gas flow can be used with any of the other configurations described herein in order to reduce the carryover of liquids with the gas-solid stream.

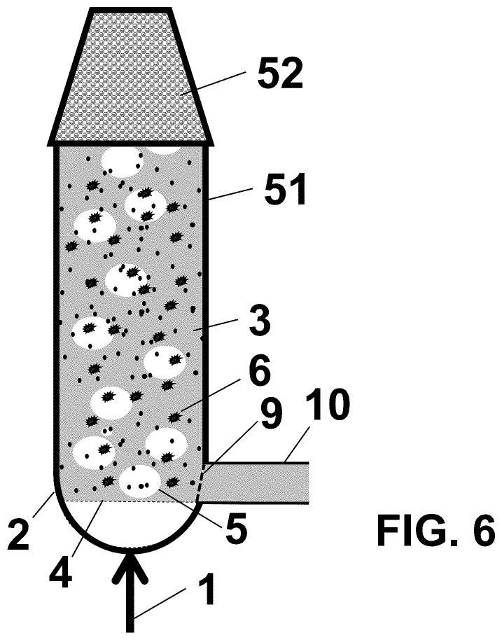

Another embodiment is shown schematically in FIG. 6, whereby gas can be introduced into a vessel 2 by a feed stream 1, and gas bubbles 5 can be formed that rise to the surface of the liquid column containing liquid 3 and solid particles 6. The bubble column or vessel 2 can be modified at the top or within an upper section 51 with a solid packing material 52 to transition the rising bubbles at the top of the column to a packed column with countercurrent liquid deposited on the packing. In some aspects, the packing material or a coating thereon can be selected for its wettability by the liquid. The packing can comprise any suitable shapes and materials such as common packed column packings (e.g., spheres, hollow spheres, rings, saddles, random packings, etc.), and in some aspects, the packing material can be formed from or have a coating of a wetting material. The packing material can be supported and retained in position within the vessel 2 using any suitable structures such as trays, perforated plates, screens, or the like. The use of the packing and selection of materials can stabilize the gas-liquid interface to reduce droplet formation, and provide surfaces on which the liquid droplets can adhere, accumulate, and flow down under the influence of gravity to the bulk liquid. Although shown as a taper in FIG. 6, the section may also expand to reduce the gas velocity allowing greater retention of droplets.

As shown and described with respect to FIG. 6, the use of a section above the liquid having a packing can help to reduce the amount of entrained liquids leaving with the gas-solid stream leaving the vessel. Accordingly, the use of the packing above the liquid can be used with any of the other configurations described herein in order to reduce the carryover of liquids with the gas-solid stream.

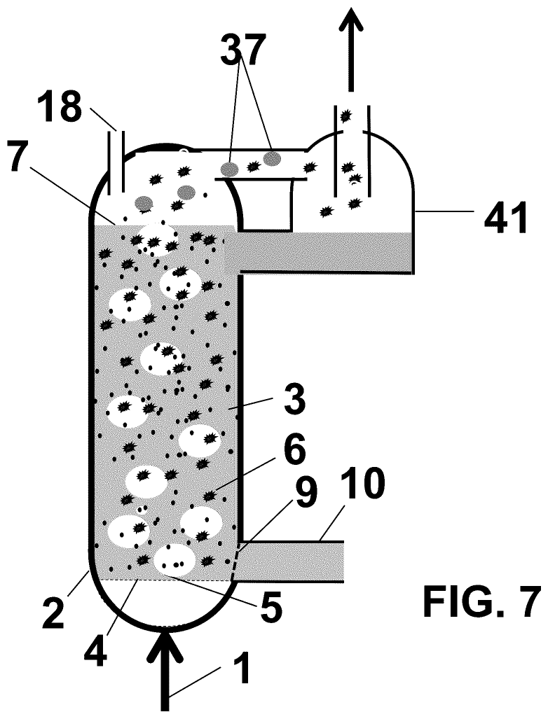

Another embodiment is shown schematically in FIG. 7, whereby gas in a feed gas stream 1 can be introduced into a reactor vessel 2, and gas bubbles 5 can be formed which rise to the surface of the liquid column containing liquid 3 and solid particles 6. The reactor vessel 2 can be modified such that the gas stream containing entrained solids and liquid droplets passes through a cyclonic separator 41 to selectively remove at least a portion of the liquid droplets. For example, the cyclonic separator 41 can remove at least a portion of any high-density liquid droplets having parameters as determined by the composition of the liquid, size of the droplets, and velocity of the gas. The liquid droplets 37 disengaged from the gas-solid suspension can return to main reactor section via a liquid communication passage. For example, the liquid can pass back to the main section through a leg at the top of the column, or pass to a lower portion of the vessel (e.g., through passage 10) to create a recirculation of the liquid. In some aspects, the inner surface of the cyclonic separator 41 can be formed from or coated with a material that is wetting with respect to the liquid to capture the droplets and allow them to fall down to the liquid without being re-entrained. Other features discussed herein can be used in combination with the cyclone to further reduce entrained liquid droplets in the gas stream.

As shown and described with respect to FIG. 7, the use of a cyclonic separator can help to reduce the amount of entrained liquids leaving with the gas-solid stream leaving the vessel. Accordingly, the use of the cyclonic separator can be used with any of the other configurations described herein in order to reduce the carryover of liquids with the gas-solid stream.

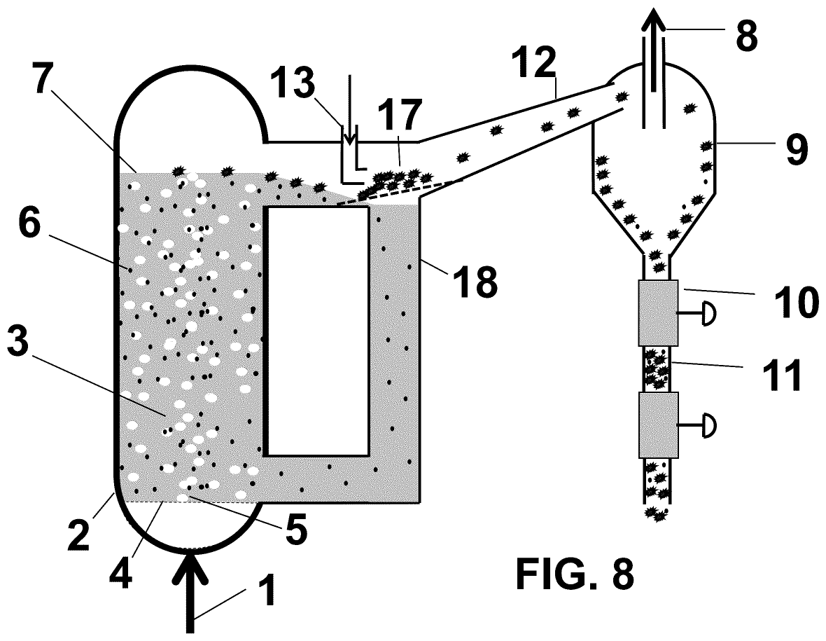

In another embodiment shown schematically in FIG. 8, the top section of the bubble column or reactor vessel 2 can be widened to allow disengagement and redirection of the gas stream towards the exit of the reactor 12. For example, the cross-sectional flow area can be increased to reduce the gas velocity. As the gas velocity is reduced, any droplets can fall back to the liquid surface while the gas moves towards the exit moving the solids towards a weir or filter 17 onto which the insoluble solids can accumulate. Gas in gas stream 13 may be introduced to one or more locations within the vessel 2 to resuspend the solids without liquid droplets in the gas-phase present and move the solids to a separation cyclone 9. The gas stream 13 can be introduced continuously, periodically, or in controlled bursts to move the solids out of the column while reducing the liquid droplet entrainment in the exiting gas-solid stream. The separation cyclone 9 may be used to remove and accumulate the solids that can be removed from the system through a series of valves.

As shown and described with respect to FIG. 8, the use of a section above the liquid having a widened cross-sectional flow area and weir or filter for the solids can help to reduce the amount of entrained liquids leaving with the gas-solid stream leaving the vessel. Accordingly, the use of the section above the liquid having a widened cross-sectional flow area will allow the droplets to drop out of suspension and the weir or filter will provide for accumulation of the solids. The widened cross-sectional flow area and weir can be used with any of the other configurations described herein in order to reduce the carryover of liquids with the gas-solid stream.

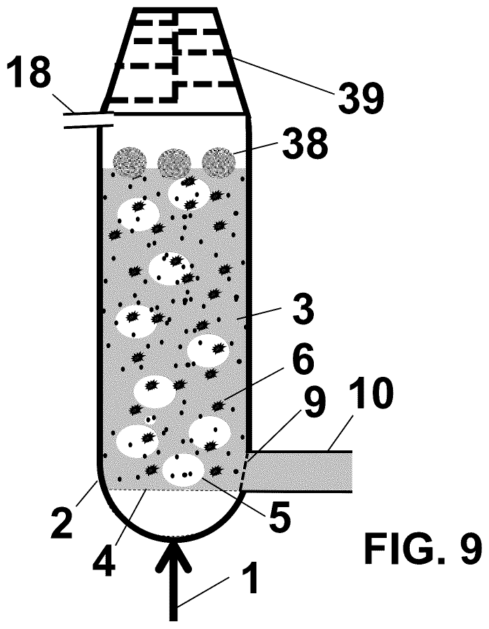

In another embodiment shown schematically in FIG. 9, materials 39 (e.g., trays, shelves, etc.), that may be wetted by the liquid, can be structured in an upper section within the vessel above the liquid 3 in the bubble column or vessel 2. The materials 39 can be configured with narrowed channels that can accelerate the gas around the structured material in a cyclonic fashion. Heavy “liquid-laden” particles have higher centrifugal forces and collide with the outer walls as the gas/solid mixture accelerates due to a reduced cross-sectional flow area (e.g., due to narrowing diameter and/or decreasing distance between trays). Additional gas stream 18 can be introduced to accelerate gas in the right direction. For example, the additional gas stream 18 can be introduced at an angle and using an inlet directed to generate an initial helical flow in the upper section. In some embodiments, the trays and upper walls can be fashioned with “veins” that allow the liquid to gather and drip back to the reactor surface. The trays, 39, can be used with or without other embodiments as disclosed herein, such as floating solids 38 or packings on the surface of the liquid. The gas-solid suspension without entrained droplets can then exit the reactor at the top of the structured section.

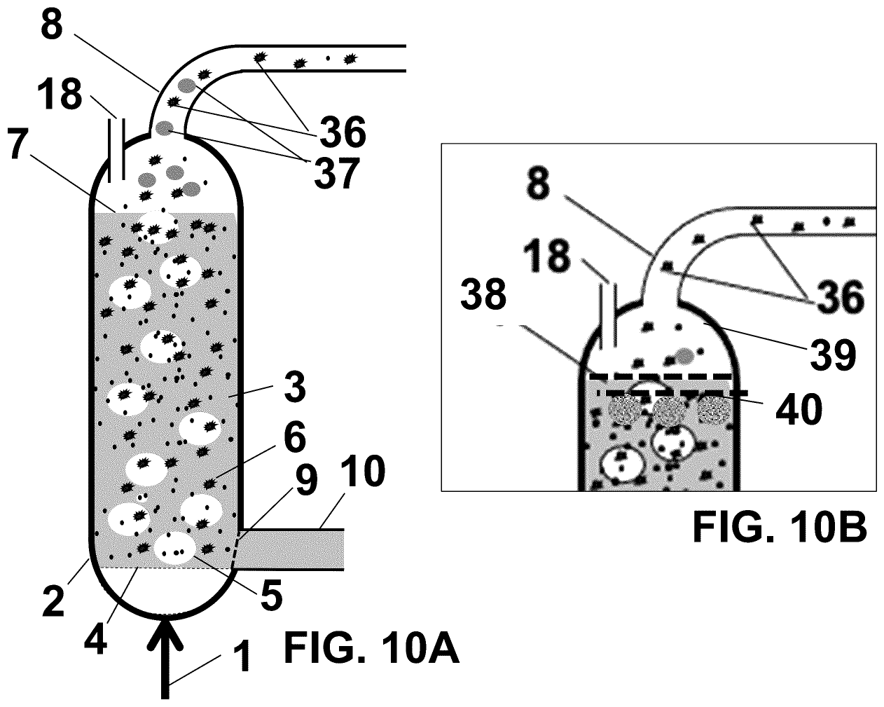

Another embodiment is shown schematically in FIGS. 10A and 10B, whereby gas is introduced as gas stream 1 into a vessel 2, and gas bubbles 5 can be formed that rise to the surface of the liquid column containing liquid 3 and solid particles 6. A solid material 40, which could include but is not limited to an unstructured packing, structured packing, a perforated plate 38, or a combination thereof can be submerge near the surface 7 of the liquid 3. The solid material 40 and/or plate 38 can act to slow down the bubble rise velocity, and/or break large slugs into smaller bubbles and reduce the turbulence at the liquid surface.

As shown and described with respect to FIGS. 10A and 10B, the use of a submerged solid layer and or perforated plate can help to reduce the amount of entrained liquids leaving with the gas-solid stream leaving the vessel. Accordingly, the use of the submerged solid layer and or perforated plate can be used with any of the other configurations described herein in order to reduce the carryover of liquids with the gas-solid stream.

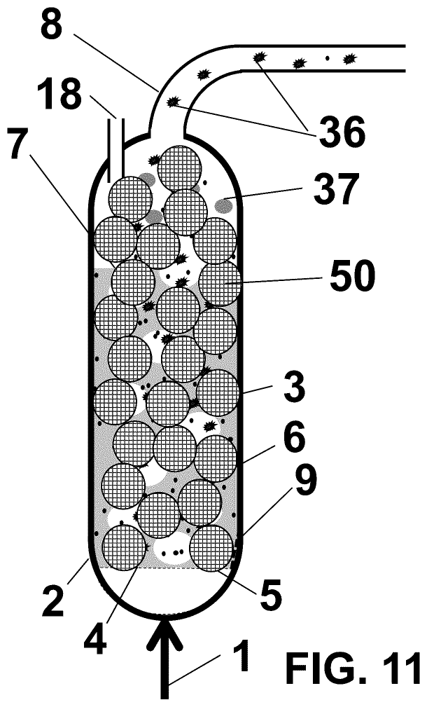

Another embodiment is shown schematically in FIG. 11 for a packed bubble column whereby a packing material 50 can be loaded above and below the top of the liquid level (e.g., disposed within the liquid) at the operating holdup to allow suspended solids 36 to leave the reactor in the exit gas stream 8 (which may be accelerated by the addition of an additional gas stream 18 to increase the exit velocity). The packing above the liquid level may allow for condensation of droplets, their aggregation, and return to the bulk liquid and the packing below the surface acts to slow down the bubble rise velocity, or break large slugs in smaller bubbles and reduce turbulence at the liquid surface. The packing material can be selected for its wettability by the liquid, which both stabilizes the gas-liquid interface reducing droplet formation, and provides surfaces above the liquid level on which the liquid droplets can adhere, accumulate, and flow down under the influence of gravity to the bulk liquid. In some aspects, the wettability of the packing material 50 can be provided by a surface coating on a packing a material.

As shown and described with respect to FIG. 11, the use of a packing within the liquid, with or without additional packing above the liquid surface, can help to reduce the amount of entrained liquids leaving with the gas-solid stream leaving the vessel. Accordingly, the use of the packing within the liquid, with or without additional packing above the liquid surface, can be used with any of the other configurations described herein in order to reduce the carryover of liquids with the gas-solid stream.

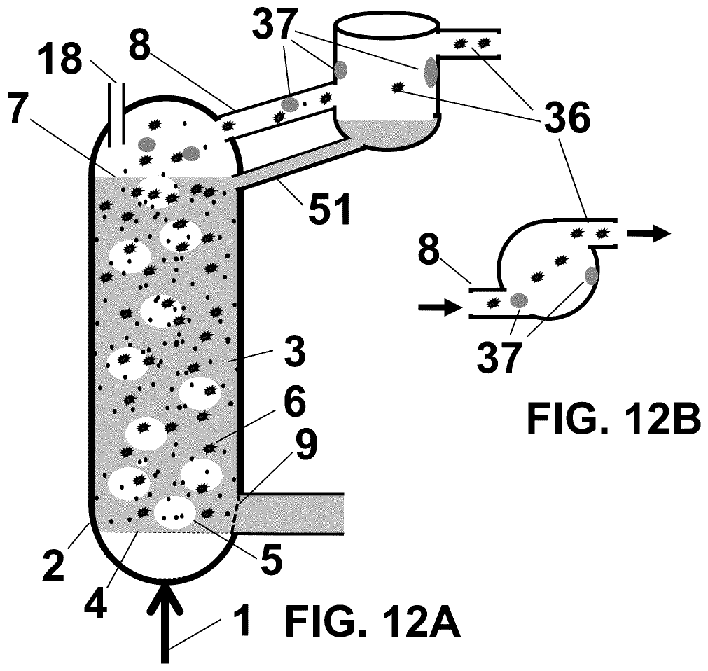

In another embodiment shown schematically in FIGS. 12A and 12B, the high velocity gas leaving the liquid (e.g., with or without the additional of gas from an additional gas stream 18) with suspended solids 36 and droplets 37 can be passed into a cylindrical vessel radially such that the suspension undergoes cyclonic flow which moves the dense liquid droplets to the wall where they condense, aggregate, and are caused to return to the bulk liquid through a return line 51. FIG. 12B illustrates a plan view of the cylindrical vessel such that the entering gas flow can enter tangentially to the interior of the cylindrical vessel and can rotate in a helical fashion prior to passing out of the cylindrical vessel. In some aspects, the cylindrical vessel may have a radius that decreases between the entrance of the gas from the vessel 2 and the outlet of the gas-solid stream.

As shown and described with respect to FIGS. 12A and 12B, the use of a cyclonic type separator with a return line can help to reduce the amount of entrained liquids leaving with the gas-solid stream leaving the vessel. Accordingly, the use of the cyclonic type separator with a return line can be used with any of the other configurations described herein in order to reduce the carryover of liquids with the gas-solid stream.

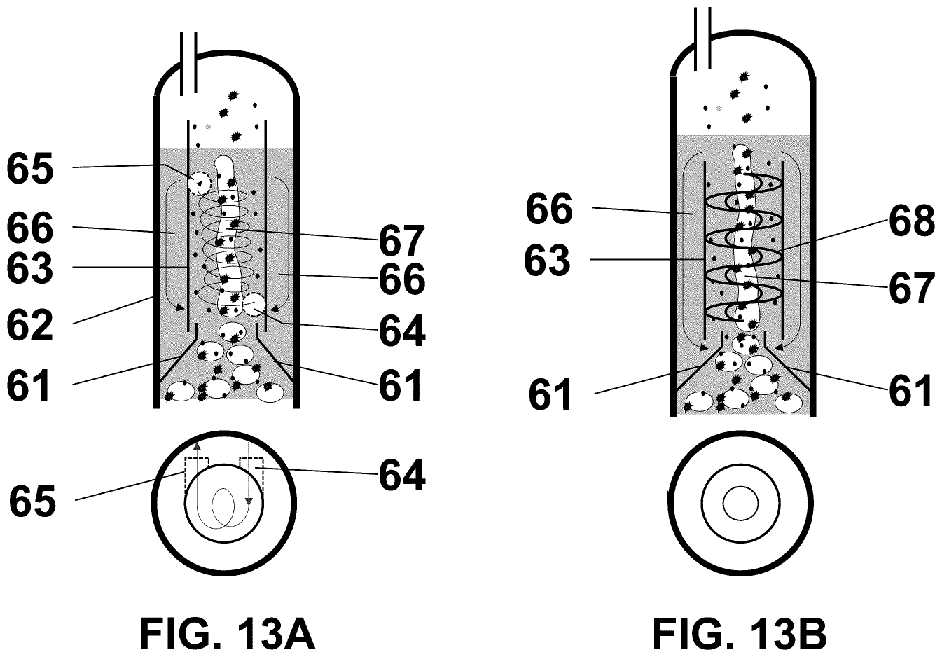

In another embodiment shown schematically in FIGS. 13A and 13B, swirling flow can be generated in the liquid itself to enforce bubble coalescence. Bubble coalescence within the liquid can reduce the number of bubbles bursting at the liquid interface. This can reduce the number of fine liquid droplets being carried over with the gas. In FIG. 13A, the system and method of generating swirling flow using the gas lift system is demonstrated. The embodiment consists of bubble deflector 61 which stays submerged in the liquid and deflects the bubbles (and solids carried with the liquid) from all of a portion of the cross-sectional area of bubble column 62 to the center of bubble column. A deflector 61 can have an opening at the center which lets the bubbles flow into the draft tube 63 placed above the bubble deflector 61. The draft tube 63 may or may not be connected to the deflector 61. The draft tube 63 can have a tangential inlet 64 at the bottom and a tangential outlet 65 at the upper portion of the draft tube 63. The region between draft tube 63 and the bubble column 62 can be an annular region 66. The liquid space inside the draft tube 63 and annular region 66 can be connected via tangential inlet 64 and tangential outlet 65. As the bubbles rise though the draft tube 63, the net liquid flow can be set between the draft tube 63 and annular region 66 due to density difference between these zones driven by gas holdup. The tangential inlet 64 can introduce or generate the swirling flow inside the draft tube 63. The swirling flow can push the bubbles towards the center of the draft tube 63, which enforces the bubble coalescence to form large slugs of gas 67. The large slug of gas 67 can reduce the number of fine droplets generated at the surface.

FIG. 13B is similar to FIG. 13A and shows a design in which swirling flow is enforced inside the draft tube 63. In this arrangement, a spiral/helical baffle 68 can be placed in the draft tube 63. The liquid in the annular region can enter the draft tube either from the gap between draft tube and deflector or from the openings provided in the lower region of draft tube. The liquid (and suspended solids) rises up with the gas bubbles through the draft tube 63. The spiral/helical baffle 68 can induce swirling flow in the draft tube 63. Swirling flow moves the gas bubbles towards the center of the draft tube 63 and enforces bubble coalescence to form gas slug. The liquid can circulate back to the bottom of draft tube 63 via the annular zone. The deflector, draft tube and baffles can be constructed from a material that is wetted by the liquid media, to direct gas contact with the surfaces and reduce driving forces for bubble migration to the submerged surfaces.

As shown and described with respect to FIGS. 13A and 13B, the use of a bubble coalescence configuration within the liquid itself can help to reduce the amount of entrained liquids leaving with the gas-solid stream leaving the vessel. Accordingly, the use of the bubble coalescence configuration within the liquid can be used with any of the other configurations described herein in order to reduce the carryover of liquids with the gas-solid stream.

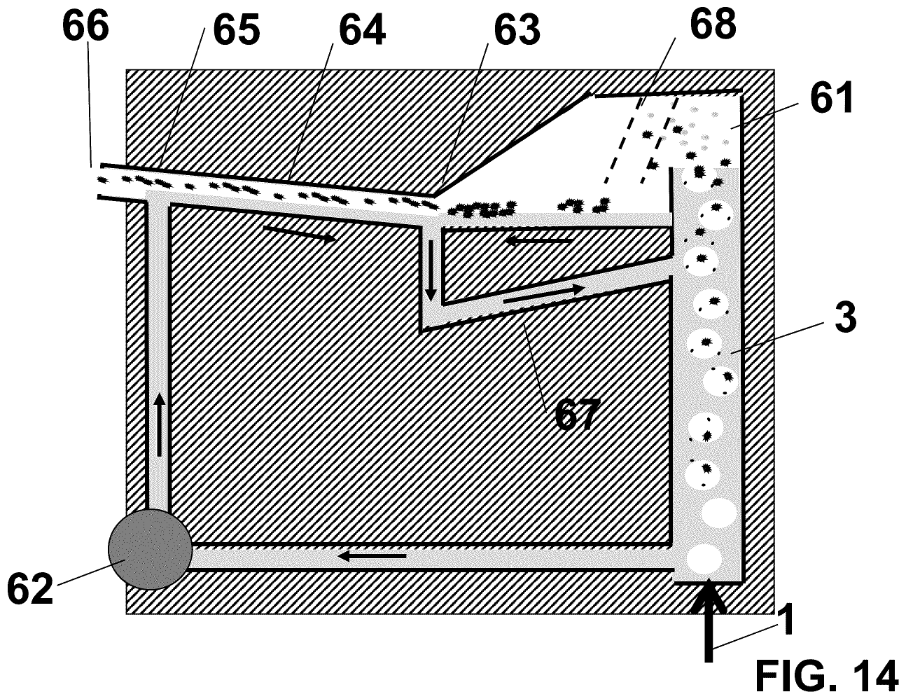

Another embodiment is shown schematically in FIG. 14. As illustrated, the gas 1 can be introduced as bubbles at the base of a liquid filled vessel with solids present. The bubbles can rise and enter the central section 3 of the vessel which may be heated to a temperature much higher than at the bottom entrance. Gas and solids can continue to rise in the bubble column. At the top of the bubble column the gas and solid can be disengaged from the liquid into a large volume headspace 61 with a long gas residence time such that the gas velocity is relatively low, and demisting internals 68 which can be wetted by the liquid media such that suspended liquid droplets fall out of suspension and solids which are insoluble in the liquid float on the liquid surface moving towards the outlet (e.g., to the left in the upper section in FIG. 14) with the liquid flow. The headspace can be well insulated and maintained at approximately the highest temperature. The headspace cross-sectional area can be reduced at the outlet 63 where the liquid can be returned to the column through a flow passage 67 under the influence of the column bubble pump. At the outlet 63, the gas stream accelerates due to the reduced cross-sectional area and can move the solid towards the system outlet in suspension 66, and at the liquid surface. The cross section of the transport section 64, is that of a wide channel to allow a large liquid surface area to be in contact with the gas for high heat transfer to the incoming cooler liquid moving counter current to the exiting gas and solid. A relatively small flowrate of the low temperature liquid cooled by the gas in stream I can be pumped from the bottom of the column to near the reactor outlet 65, possibly with a motive device such as a pump 62. The relatively low temperature liquid can be introduced at the reactor outlet 65 and flow under gravity counter current to the exiting gas-solid suspension. The liquid can be heated through the large liquid surface area while cooling the exit stream. The heated liquid can then pass through the flow passage 67 back to the column. This allows the heat of the exiting gas to be recovered into the reactor internal heat. The exit stream can be a gas-solid suspension which may be further cooled and separated using a cyclone and/or bag filter.

As shown and described with respect to FIG. 14, the use of a large volume headspace above the bubble column, a reduced outlet cross-section to collect the solids on the liquid, and a recirculating liquid flow to exchange heat with the existing gas and solid stream can help to reduce the amount of entrained liquids leaving with the gas-solid stream leaving the vessel as well as retain heat within the system. Accordingly, the use of the large volume headspace above the bubble column, the reduced outlet cross-section to collect the solids on the liquid, and the recirculating liquid flow to exchange heat with the existing gas and solid stream can be used with any of the other configurations described herein in order to reduce the carryover of liquids with the gas-solid stream.

In some aspects, the system as shown in FIG. 14 can be used for the formation of solid carbon from the decomposition of a hydrocarbon containing gas in stream 1 entering the reactor and producing solids and droplets at the top 61 of the bubble column. The widened cross-sectional flow area can allow the droplets to drop out of suspension, which can be aided by perforated structures 68 to allow accumulation of droplets. The liquid can flow through the flow passage 67 driven by the bubble lift pumping of the column allows buoyant particles (e.g., solid carbon) to accumulate at the outlet 63 and be fluidized by the accelerated gas at the headspace exit traveling above the liquid introduced at the reactor exit 65. The liquid at the gas inlet can be cooled by the inlet gas and a fraction of the cooled liquid can be pumped 62 to the reactor exit 65 where it is allowed to flow counter current back to the reactor top section and be heated with the exiting gas solid suspension flowing above transport section 64.

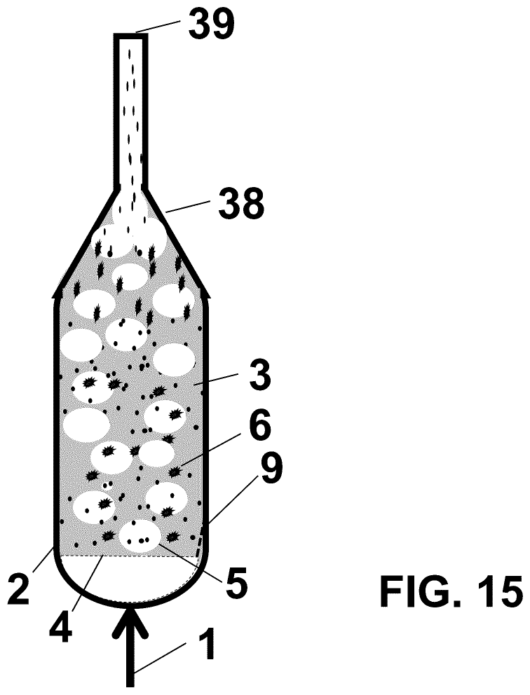

In another embodiment shown schematically in FIG. 15, a multiphase bubble column can comprise similar components as described herein including a liquid 3 contained within a vessel 2 and having a gas feed 1 that created bubbles 5 that rise through the liquid. In this embodiment, the diameter of the vessel 2 can form a narrowed region 38 at an upper section to force the bubbles to coalesce and increase the gas holdup in the narrowed region 38. This can transform the flow to annular with the liquid bubble residue wetting the riser section above the narrowed section 38 and result in a gas solid suspension at the vessel exit 39.

As shown and described with respect to FIG. 15, the use of a narrowed section at the outlet above the liquid level can help to reduce the amount of entrained liquids leaving with the gas-solid stream leaving the vessel as well as retain heat within the system. Accordingly, the use of the narrowed section at the outlet above the liquid level can be used with any of the other configurations described herein in order to reduce the carryover of liquids with the gas-solid stream.

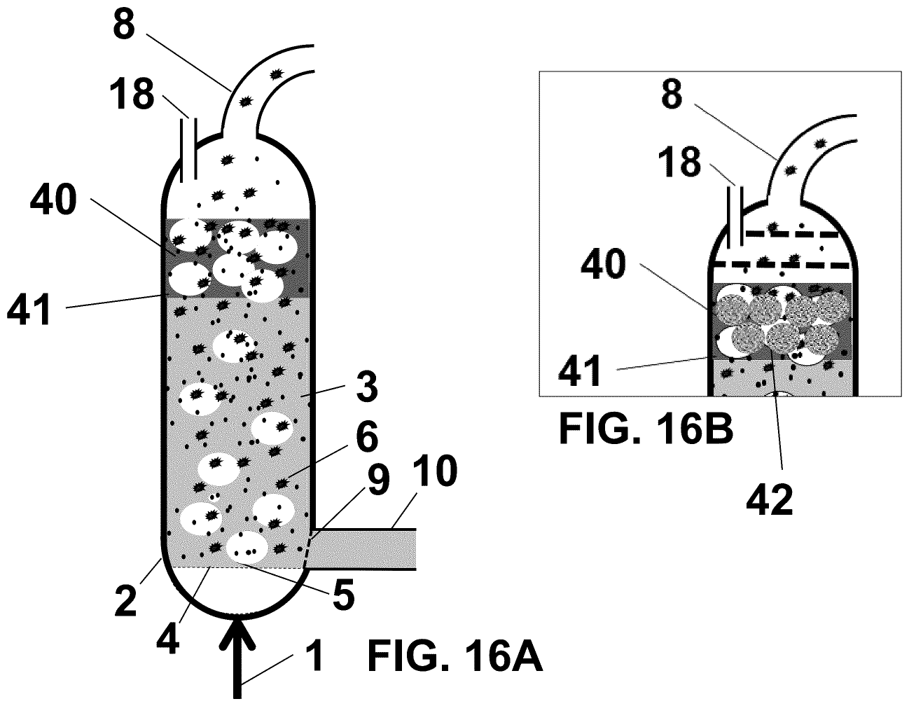

Another embodiment is shown schematically in FIG. 16A and FIG. 16B. In this embodiment, an immiscible fluid 40 can sit on top of the liquid 3 constituting the bubble column. This immiscible fluid is of a lower density than the liquid 3. As bubbles 5 rise through the column and cross the interface 41 between the liquid 3 and the immiscible fluid 40, the liquid 3 can be shed off the bubble surface and remains sequestered in the lower liquid column. Any liquid 3 passing into the immiscible liquid 40 may settle and coalesce into the liquid 3 based on density differences. The physical properties, including, but not limited to, surface tension and viscosity, of the immiscible liquid 40 can be selected such that liquid droplet formation in the gas headspace is mitigated as the bubbles breach the surface of 40. The immiscible fluid 40 may also contain other configurations as described herein, which can include, but is not limited to, an unstructured packing, structured packing, a perforated plate, or a combination thereof submerged within the immiscible fluid 40 or at its surface. The packing acts to agitate the solid-gas suspension and “wash” the liquid 3 from the entrained solids inside the rising bubble 5.

As shown and described with respect to FIGS. 16A and 16B, the use of an immiscible fluid layer above the liquid level, with or without additional packings, can help to reduce the amount of entrained liquids leaving with the gas-solid stream leaving the vessel as well as retain heat within the system. Accordingly, the use of the immiscible fluid layer above the liquid level, with or without additional packings, can be used with any of the other configurations described herein in order to reduce the carryover of liquids with the gas-solid stream.

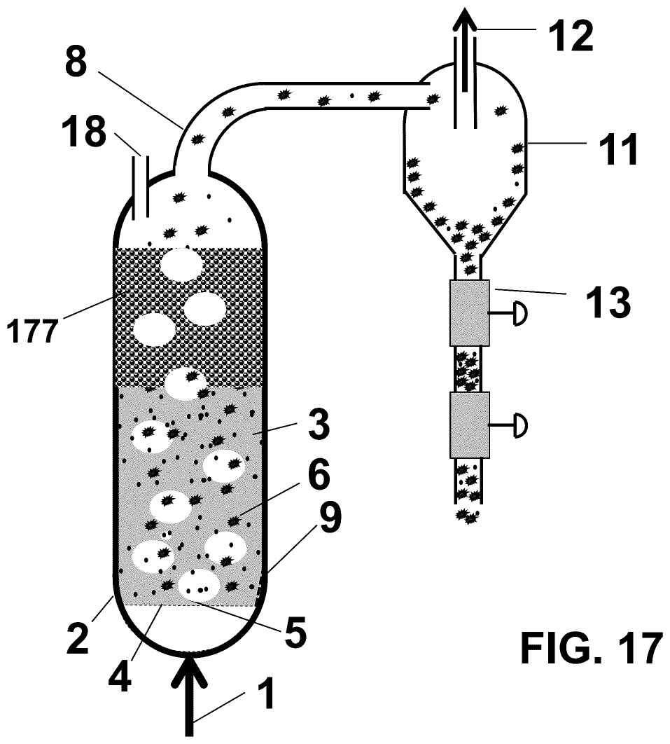

As illustrated in FIG. 17, another embodiment uses a fluidized or bubbling bed of solid on top of a liquid filled bubble column to disengage the gas and solid from the liquid and produce a clean, droplet free gas stream. As shown, gas can be introduced in feed stream 1 into a vessel 2 filled with liquid 3, and gas bubbles 5 can be formed that rise to the surface of the liquid column. A lower density solid bed 177 can be positioned on top of the liquid column. In some aspects, the solid bed can comprise any of the particles as described with respect to the layer of solids 38 in FIG. 4B (e.g., metals, ceramic particles, etc.). When the solid bed 177 is less dense than the liquid, the solid bed 177 can float on the top of the liquid. The gas leaving the surface of the liquid can continue to rise within the solid bed under either bubbling bed or fluidized bed conditions. Any liquid droplets formed when the gas and solid phases rising in the liquid bed disengage at the top of the liquid can be contained within the solid bed. The gas flow rate and conditions are such that any liquid containing solid particles are stratified to the bottom of the bubbling or fluidized solid column, coalesce, and return to the liquid. At the top of the solid bed, the solid is caused by the gas velocity of the exiting stream to be suspended and removed from the reactor 8, for further separation in a cyclone 11, or other gas-solid separation unit.

In some aspects, the solids can be selected to provide for an appropriate density difference to result in a layered structure within the lower density solid bed 177. Within the solid bed 177, the solid particles being separated can accumulate. When the solid particles are less dense that the materials of the solid bed 177, the solid particles may migrate upwards within the solid bed 177 to form a layered structure having the less dense solid particles on top, with the materials of the solid bed 177 above the upper liquid surface, and a gradient in the mixture of the solid bed 177 and solid particles between the upper liquid surface and the accumulated solid particles on top of the solid bed 177. Within the solid bed 177, the materials forming the solid bed 177 can mix with and mechanically agitate the solid particles being separated. This mixture can serve to remove some portion of any entrained liquids or solidified liquids as well as mechanically milling the solids within the vessel 2, which may be referred to as in-situ milling in some contexts.

As shown and described with respect to FIG. 17, the use of a fluidized or bubbling bed of solid on the liquid can help to reduce the amount of entrained liquids leaving with the gas-solid stream leaving the vessel as well as retain heat within the system. Accordingly, the use of the fluidized or bubbling bed of solid on the liquid can be used with any of the other configurations described herein in order to reduce the carryover of liquids with the gas-solid stream.

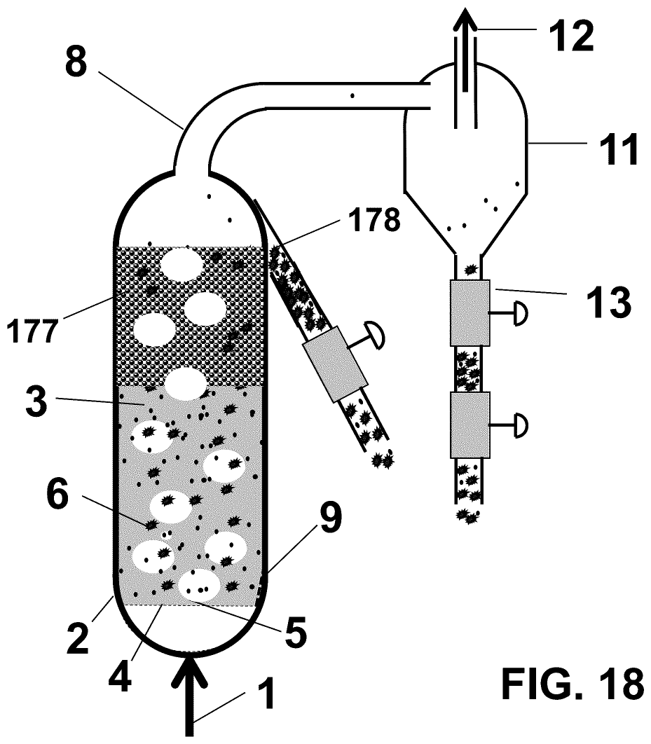

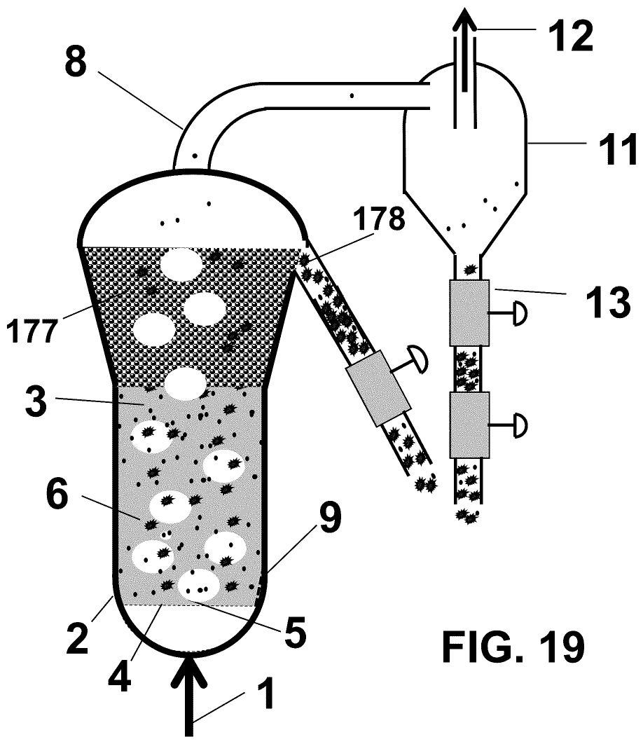

A further embodiment of the lower density solid bed 177, on top of a bubble column, is shown schematically in FIG. 18, whereby rather than have the solid discharged as a suspension in the gas, a separate solids stream exits the reactor either through a gravity fed tap 178 or a mechanical auger or other means of selecting the top, liquid-free, layers of the stratified solid column. A cyclone or other solid-gas filtration system may still be used to retrieve any minor fractions of the solid which inadvertently exit in the gas stream. In a further embodiment shown schematically in FIG. 19, the solid bed is of variable diameter to allow bed expansion and improved stratification allowing the heavier, liquid contaminated, solids to be segregated to the bottom of the solid bed.

As shown and described with respect to FIGS. 18 and 19, the use of a fluidized or bubbling bed of solid on the liquid with a solid takeoff and/or a widened section for the fluidized or bubbling bed can help to reduce the amount of entrained liquids leaving with the gas-solid stream leaving the vessel as well as retain heat within the system. Accordingly, the use of the fluidized or bubbling bed of solid on the liquid with a solid takeoff and/or a widened section for the fluidized or bubbling bed can be used with any of the other configurations described herein in order to reduce the carryover of liquids with the gas-solid stream.

When the gas-solid removal is performed in two streams, one predominately gas and one predominately solid, the methods available for phase separation and segregation can exploit the density differences of the solids and liquids and the wettability properties of the solid/liquid phases. The methods and devices utilize combinations of elements as described herein including: 1) disengagement of the three-phase mixture into a predominately gas phase stream and solid-liquid stream, where the initial disengagement zone can have a relatively long gas residence time, low gas flow velocity, and features for phase separation and segregation of the condensed phase; and, 2) decantation and removal of low density non-wetting solid from the liquid phase surface. The system can include liquid flow management for localization and segregation of solid and subsequent solid stream flow management.

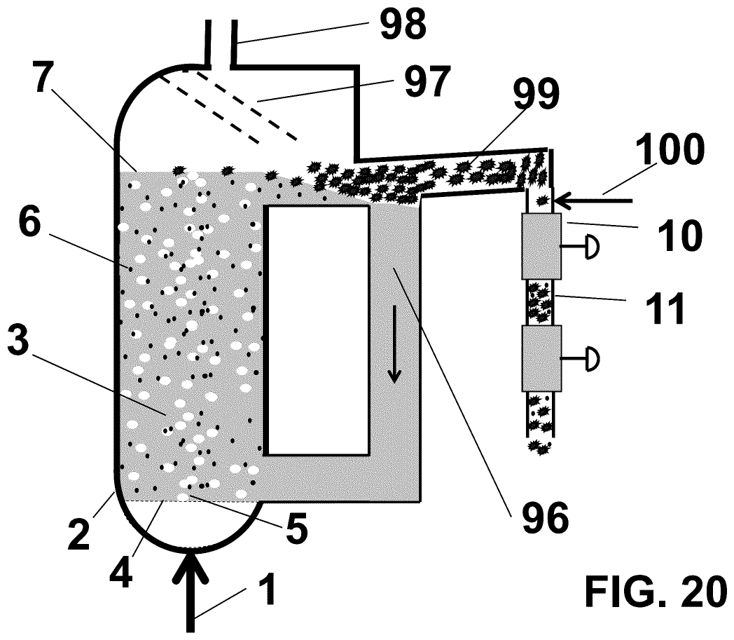

In an embodiment as shown schematically in FIG. 20, a gas stream I can enter a vessel 2 containing both liquid 3 and solid materials 6, where the gas can form bubbles 5. The solids can be of lower density than the liquid 3, which can be selected for non-wetting behavior of the introduced and/or formed solids that rise to the surface together with the gas bubbles. Above the liquid surface 7 there can be a disengagement sub-system volume which is of sufficient size and flow cross-sectional area that the gas velocity is insufficient to suspend or entrain either liquid droplets or solid particles and both can return under gravity to the liquid surface 7. Further, physical barriers 97, which may have perforations, can be located within the volume where droplets and particles produced at the surface and ejected into the volume will collide, lose their momentum, and return to the liquid surface. The barriers 97 can be constructed of a material that is wetted by the liquid 3 to promote separation of the droplets by the gas. The gas within the vessel 2 moves to the gas exit 98, where gas leaves the vessel without or with only minor amounts of liquid and/or solid. The vessel 2 can be configured as a bubble lift system whereby the rising gas in the main bubble section (e.g., on the left side of FIG. 17) decreases the average volumetric density of the multiphase column relative to the liquid downcomer (e.g., on the right-hand side of FIG. 17) and causes a liquid circulation through the liquid return loop 96 (e.g., the downcomer). The slow circulation moves the liquid with solid material floating on the surface towards the downcomer 96 (e.g., the right in FIG. 17) accumulating the floating solid over the down-going return liquid stream. By virtue of the low solid density and its non-wettability, the solid remains separate on top of the liquid. In some embodiments, the solid can be conveyed from the site of accumulation out of the reactor using mechanical transport such as an auger. The accumulated solid may also be conveyed using gas introduced in the conveyance tube 99. It may be helpful to purge the conveyed solid of gas from the reactor. An inert or other gas can be introduced at inlet 100 at a slow flow rate to avoid fluidization or suspension of the solids and made to flow counter-current to the solids.

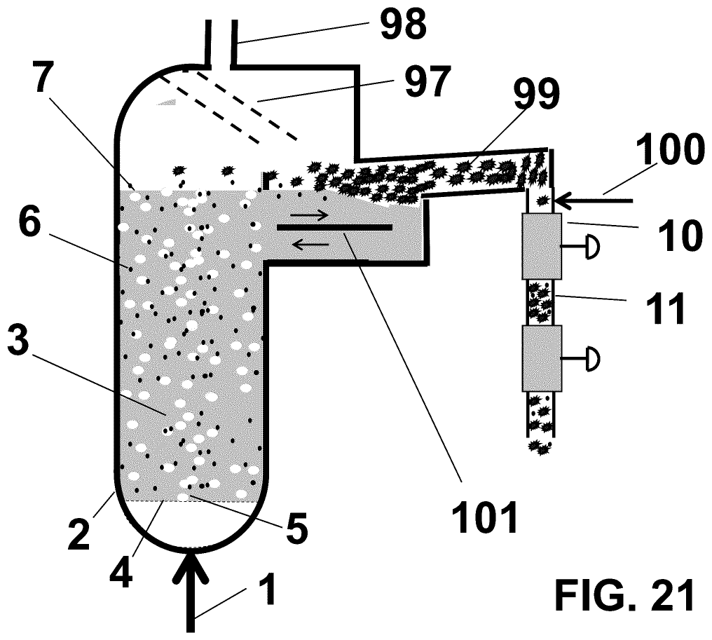

Another embodiment is shown schematically in FIG. 18. The embodiment illustrated in FIG. 18 is similar to that described with respect to FIG. 17, and the like components may not be described in the interest of brevity. As illustrated, a gas feed stream I can enters a vessel 2 containing both liquid 3 and solid materials 6, where the gas can form bubbles 5 that can rise through the liquid 3. In some embodiments, the solids can be of a lower density than the liquid and non-wetting so as to rise to the surface together with the gas bubbles. At the liquid surface, there can be a disengagement sub-system volume which can be of sufficient size that the gas velocity is insufficient to suspend or entrain either liquid droplets or solid particles and both return under gravity to the liquid surface. Further, physical barriers 97, which may have perforations, can be located within the volume where droplets and particles produced at the surface and ejected into the volume will collide, lose their momentum, and return to the liquid surface. The gas within the vessel can move to the gas exit 98, where gas leaves the vessel without or with only minor amounts of liquid and/or solid. As the bubbles break the surface, the liquid on and near the surface can move to the side (e.g., moves to the right in FIG. 18) to carry the solids floating on the surface with them, where the solids accumulate on the liquid surface at a solids collection point (e.g., the right of FIG. 18). Within the liquid, a physical barrier 101 (e.g., as shown in FIG. 21) may be used to stratify liquid and solids moving to the solids collection point on the top of the barrier, and a return circulation pathway can be provided under the barrier 101 such that circulation can be driven by the rising bubbles in the column. The slow circulation can move the liquid with solid material floating on the surface to the solids collection point, thereby accumulating the floating solids within the vessel 2. By virtue of the low solid density and its non-wettability, the solid can remain separate on top of the liquid. In some embodiments, the solid can be conveyed from the site of accumulation out of the reactor using mechanical transport such as an auger. It may also be conveyed using an additional gas stream introduced in the conveyance tube 99. It may be helpful to purge the conveyed solid of gas from the reactor. An inert or other gas can be introduced, 100, at a slow flow rate to avoid fluidization or suspension of the solids and made to flow counter-current to the solids.

As disclosed herein, there are a number of advantages and benefits proposed by the systems and methods described herein. When the systems and methods are applied to methane pyrolysis, the systems and methods allow for the management of the solid carbon and gas phase hydrogen products of hydrocarbon pyrolysis leaving a high temperature molten metal or molten salt bubble column. For example, cyclonic flow can be used to reduce the amount of liquid carried into the hydrogen-carbon product stream, where the cyclonic flow can occur within the reactor in an external cyclone separator. Further, the application to hydrocarbon pyrolysis allows the liquids to not wet the solids produced in the reaction, which allows for an improved separation of the solids and liquids, as well as a better disengagement of the solids at the upper surface of the liquid. The use of the various systems and methods such as the use of a packing material within and/or above the liquid surface, with or without an immiscible liquid within the packing, can be used to capture the liquid droplets.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

### Surface Dampening and Liquid Impingement

In a specific example, a molten tin bubble column at 600° C. containing solid particles of carbon is used for the conversion of hydrocarbons to solid carbon and hydrogen gas. The carbon is not wetted by the molten tin and at the liquid surface is carried into a gas-solid suspension. Reference is made to FIG. 4B. A layer of ceramic quartz balls, 38, approximately 5 mm in diameter are layered at the molten tin surface which dampen the bursting bubbles and reduce the number of molten tin droplets generated at the surface and entrained in the gas. Above the liquid surface covered with the floating quartz balls is positioned five layers of tungsten mesh with 5 mm openings. The tin droplets strike the mesh surface and are retained, whereas the carbon particles and gas pass through the mesh and exit the vessel. Liquid tin accumulates on the mesh and drips back into the liquid column.

### Example 2

### Bubble Diversion and Liquid Impingement

In a specific example, a molten tin bubble column at 600° C. containing solid particles of carbon is used for the conversion of hydrocarbons to solid carbon and hydrogen gas. The carbon is not wetted by the molten tin and at the liquid surface is carried into a gas-solid suspension. Reference is made to FIG. 5. The top of the bubble column is modified to increase the liquid surface area and allow for a longer path for liquid droplets to fall out under gravity. Further, tungsten mesh with 5 mm openings is suspended from the vessel surface 39, whereby tin droplets moving towards the exit 42, strike the mesh surface and are retained, while the carbon particles and gas pass through the mesh and exit the vessel. Liquid tin accumulates on the mesh and drips back into the liquid column. To ensure suspension of solids additional gas is added to the vessel top above the melt 18.

### Example 3

### Gas-Liquid Surface Stabilization and Liquid Impingement

In a specific example, a molten tin bubble column at 600° C. containing solid particles of carbon is used for the conversion of hydrocarbons to solid carbon and hydrogen gas. Reference is made to FIG. 6. The carbon is not wetted by the molten tin and the top of the bubble column is packed, 51, with materials wetted by the liquid. In this example, the packing at the top of the column consists of 5 mm diameter tungsten balls on to which the liquid tin droplets entrained in the gas-solid suspension impinge and accumulate liquid from other droplets eventually running back into the bulk liquid.

### Example 4

### Gas-Liquid Surface Stabilization and Liquid Impingement

In a specific example, a molten tin bubble column at 1100° C. containing solid particles of carbon is used for the conversion of hydrocarbons to solid carbon and hydrogen gas. Reference is made to FIG. 16. The carbon is not wetted by the molten tin. A column of an immiscible, lower-density fluid sits on top of the molten tin. In this example, the immiscible fluid is a molten oxide. A foam of the molten oxide forms at high gas holdup. Droplet formation is mitigated at the surface due to the high viscosity of the fluid, which retards film retraction upon bubble collapse.

### Example 5

### Disengagement and Heat Integration

In a specific example, 3000 sccm of methane is bubbled through a molten tin bubble column to produce solid carbon and hydrogen gas as shown schematically in FIG. 14. The methane gas is introduced in stream 1 as bubbles at the base of the 4 cm diameter solid packed bed reactor maintained at 500° C. at the base by the specific heat of the incoming low temperature methane. The bubbles rise and enter the central section 3 of the reactor maintained at 1200° C. by resistance heaters in contact with the melt. Methane pyrolysis converts the methane to hydrogen and solid carbon which continue to rise in the 1 meter constant diameter bubble column. At the top of the bubble column the gas and solid are disengaged from the liquid into a large volume headspace 61 with a gas residence time of more than 30 seconds, relatively low gas velocity, and demisting internals such that suspended liquid droplets fall out of suspension and solid carbon which is insoluble in tin collects, floating on the molten tin surface and moving towards the left with the liquid flow. The headspace is well insulated and maintained at approximately 1200° C. The headspace cross-sectional area is reduced at the outlet 63, where the liquid is returned to the column 67 under the influence of the column bubble pump. At the outlet the gas stream accelerates moving the solid carbon towards the system outlet 66 at the liquid surface and in suspension 64. The cross section of the transport section 64 is that of a wide channel to allow a large liquid surface area to be in contact with the gas for excellent heat transfer. A relatively small flowrate of low temperature liquid tin cooled by the inlet gas in stream 1 is pumped from the bottom of the column to near the reactor outlet 65 with a metal pump 62 the relatively low temperature metal (500° C.) is introduced at 65 and flows under gravity counter current to the exiting gas-solid suspension and is heated by the large liquid surface area, while cooling the exit stream. This allows the heat of the exiting gas to be recovered into the reactor internal heat. The exiting gas-solid suspension is further cooled and separated using a cyclone and bag filter.

### Example 6

In a specific example, a molten bismuth bubble column at 1100° C. is used for the conversion of hydrocarbons to solid carbon and hydrogen gas. The carbon generated is not wetted by the molten bismuth, and at the liquid surface, is carried into a gas-solid suspension. Reference is made to FIG. 3 and FIG. 5. The use of a specific bismuth melt as opposed to a tin melt referenced in previous molten metal examples provided herein, generates a carbon product of much finer particle distribution promoting enhanced entrainment of the solid particle in the gas suspension due to extremely low Stoke's equivalent diameters generated specifically by this melt selection. This specific example can be combined with previous embodiments such as positioning five layers of tungsten mesh with 5 mm openings, which are wetted by molten Bi at high temperatures. The Bi droplets strike the mesh surface and are retained, whereas the carbon particles and gas pass through the mesh and exit the vessel. Liquid Bi accumulates on the mesh and drips back into the liquid column.

### Example 7

### Removal of Separate Gas and Solid Streams

In a specific example, methane is bubbled through a molten tin bubble column at 1100° C. to produce solid carbon and hydrogen gas as shown schematically in FIG. 20. The reactor is configured as a bubble lift pump such that the molten tin circulates clockwise which causes the solid carbon floating on the top of the melt to move to the right of the figure and accumulate in the reservoir tube 99. A mechanical auger was used to move the accumulating solid carbon to a gravity fed exit tube where the carbon is removed from the system. The reactor headspace is sufficiently large to enable droplets to fall out of suspension and the gas to be removed separately from the carbon 98.

### Example 8

### Stratified Solid Bed on Top of Liquid Bubble Column

In a specific example, 1 standard liter per minute of methane is bubbled into a 24 inch tall, 4 inch diameter molten tin bubble column maintained at 1200° C. The methane undergoes pyrolysis and produces solid carbon particles and hydrogen gas which are carried upward. The carbon floats on top of the liquid and builds up a loose solid carbon bed approximately 12 inches in height through which the gas leaving the liquid bubble column rises. The gas and solid moving out of the liquid bubble column move through the solid bed and all the dense liquid droplets produced at the top of the liquid column are retained in the solid bed where they aggregate and return to the liquid. At the top of the solid column a quench gas stream of hydrogen is introduced which produces a solid-gas suspension only of the top layer of the carbon solid bed which is free of metal contamination.

Having described various reactors, systems, and methods, certain embodiments as disclosed herein can include, but are not limited to:

In a first embodiment, a process is disclosed herein for management of a mixture of gases, liquids, and solids at the bulk liquid surface where the number of droplets produced at the gas-liquid interface is minimized by: i) stabilization of the liquid surface to reduce droplet formation, and/or ii) the bubbles are diverted or redirected to allow accumulation of droplets on surfaces, and/or iii) bubbles are caused to coalesce to form larger bubbles with less droplets. Further, the droplets remaining entrained in the gas-solid suspension can be removed by i) impingement on solid surfaces to which the droplets wet and adhere, and/or ii) centripetal segregation and accumulation on the walls surrounding a cyclonic flow field.

A second embodiment can include the process of the first embodiment where the gas-liquid interface is stabilized by dampening fluid motion with a layer of floating or fixed solids that are large compared to the size of the suspended solids in the gas.

A third embodiment can include the process of the first embodiment where the gas-liquid interface is modified by increasing the liquid surface area and increasing the distance required for liquid droplets to travel prior to exiting the vessel allowing disengagement by gravitational sedimentation or through contacting surfaces.

A fourth embodiment can include the process of the first embodiment where the suspended solids and liquid droplets entrained in the gas are passed through perforated surfaces that are wetted by the liquid droplets and retained while the gas and solids remain as a suspension.

A fifth embodiment can include the process of the first embodiment where the suspended solids and liquid droplets entrained in the gas are passed through a packed bed of materials that are wetted by the liquid droplets and retained while the gas and solids remain as a suspension.

A sixth embodiment can include the process of the first embodiment where the bulk liquid consists of a high temperature molten salt or molten metal in which solid carbon has been produced from hydrocarbon decomposition.

A seventh embodiment can include the process of the first embodiment where the bulk liquid consists of a high temperature molten salt or molten metal in which solid carbon has been produced from hydrocarbon decomposition where the carbon particle size distribution has been targeted to enhance conveyance by liquid media selection that promotes a finer PSD.

Additional aspects as disclosed herein can include, but are not limited to:

In a first aspect, a system comprises: a vessel having a gas inlet and a gas outlet; a liquid within the vessel, wherein the liquid comprises an upper liquid surface within the vessel; a solid phase and a gas phase present within the vessel; and at least one liquid separator disposed within the vessel, wherein the liquid separator is configured to remove at least a portion of liquid droplets generated based on the gas phase and the solid phase passing through the liquid.

A second aspect can include the system of the first aspect, wherein the at least one liquid separator comprises: one or more solids disposed at the upper liquid surface within the liquid.

A third aspect can include the system of the second aspect, wherein the one or more solids have a lower density that a density of the liquid, and wherein the one or more solids float on the liquid.

A fourth aspect can include the system of the first or second aspect, wherein the one or more solids comprise spheres, rods, cubes, saddles, or rings.

A fifth aspect can include the system of any one of the first to fourth aspects, where the at least one liquid separator comprises: a perforated plate disposed above the upper liquid surface, where the perforated plate is disposed between the upper liquid surface and the gas outlet, and wherein the gas phase and the solid phase are configured to pass through or around the perforated plate before passing out the gas outlet.

A sixth aspect can include the system of the fifth aspect, wherein a surface of the perforated plate comprises a wetting material with respect to the liquid.

A seventh aspect can include the system of any one of the first to sixth aspects, wherein the at least one liquid separator comprises a widened upper chamber within the vessel, wherein the widened upper portion has a larger cross-sectional gas flow area than the cross-sectional flow area of the upper liquid surface.

An eighth aspect can include the system of the seventh aspect, wherein the at least one liquid separator further comprises a weir disposed at or near the gas outlet within the widened upper chamber, wherein the weir is configured to collect the solid phase upstream of the gas outlet.

A ninth aspect can include the system of any one of the first to eighth aspects, wherein the at least one liquid separator comprises a packing material disposed above the upper liquid surface.

A tenth aspect can include the system of the ninth aspect, wherein the packing material comprises a packed bed supported above the upper liquid surface.

An eleventh aspect can include the system of the ninth aspect, wherein the packing material comprises a fluidized bed or a bubbling bed above the upper liquid surface.

A twelfth aspect can include the system of the eleventh aspect, wherein the vessel comprises a widened diameter section above the upper liquid surface, and wherein the fluidized bed or the bubbling bed is disposed in the widened diameter section.

A thirteenth aspect can include the system of any one of the ninth to twelfth aspects, wherein a surface of the packing comprises a wetting material with respect to the liquid.

A fourteenth aspect can include the system of any one of the first to thirteenth aspects, wherein the at least one liquid separator comprises a cyclonic separator disposed in an upper portion of the vessel between the upper liquid surface and the gas outlet, wherein the cyclonic separator is configured to remove at least the portion of liquid droplets generated based on the gas phase and the solid phase passing through the liquid using centrifugal force.

A fifteenth aspect can include the system of any one of the first to fourteenth aspects, wherein the at least one liquid separator comprises one or more trays arranged in a helical configuration, wherein the one or more trays are disposed above the upper liquid surface and the gas outlet, wherein the one or more trays are configured to form a helical path for the gas phase above the upper liquid surface.

A sixteenth aspect can include the system of any one of the first to fifteenth aspects, wherein the at least one liquid separator comprises one or more solid elements submerged in the liquid below the upper liquid surface.

A seventeenth aspect can include the system of any one of the first to sixteenth aspects, wherein the at least one liquid separator comprises at least one perforated plate submerged in the liquid below the upper liquid surface.

An eighteenth aspect can include the system of any one of the first to seventeenth aspects, wherein the at least one liquid separator comprises a packing disposed within the liquid.

A nineteenth aspect can include the system of the eighteenth aspect, wherein the packing is disposed within and above the liquid.

A twentieth aspect can include the system of the eighteenth or nineteenth aspect, wherein the packing has a wetting surface relative to the liquid.

A twenty first aspect can include the system of any one of the first to twentieth aspects, further comprising: a cyclonic separator fluidly coupled to the gas outlet, and a return line fluidly connecting a liquid outlet of the cyclonic separator to the vessel.

A twenty second aspect can include the system of any one of the first to twenty first aspects, wherein the at least one liquid separator comprises: a draft tube disposed within the liquid, wherein the gas inlet and the draft tube are configured to contain bubbles of the gas phase rising from the gas inlet through the liquid.

A twenty third aspect can include the system of the twenty second aspect, wherein the draft tube is further configured to generate a helical flow of the liquid within the draft tube and force the bubbles to the center of the draft tube.

A twenty fourth aspect can include the system of the twenty second or twenty third aspect, further comprising a deflector disposed below the draft tube, wherein the deflector is configured to pass the bubbles in a tangential direction within the draft tube.

A twenty fifth aspect can include the system of any one of the twenty second to twenty fourth aspects, further comprising a baffle disposed within the draft tube, wherein the baffle has a helical surface configured to direct the bubbles in a helical pattern within the draft tube.

A twenty sixth aspect can include the system of any one of the first to twenty fifth aspects, wherein the vessel comprises: a headspace above the upper liquid surface, wherein a cross-sectional flow area in the headspace is greater than a cross sectional area of the upper liquid surface; a first outlet point, wherein a cross sectional flow area of the first outlet point is less than the cross-sectional flow area in the headspace; a liquid return line fluidly coupling the first outlet point with the liquid in the vessel; and a transport section fluidly coupling the first outlet point to the gas outlet.

A twenty seventh aspect can include the system of the twenty sixth aspect, further comprising: a fluid pump fluidly coupled with a lower portion of the liquid and the transport section, wherein the fluid pump is configured to pass a portion of the liquid from the lower portion of the liquid to the transport section, wherein the liquid is configured to exchange heat with the portion of the liquid and the gas phase passing through the transport section to the gas outlet.

A twenty eighth aspect can include the system of any one of the first to twenty seventh aspects, wherein the at least one liquid separator comprises a narrowed section above the upper liquid surface, wherein the narrowed section is disposed between the upper liquid surface and the gas outlet.

A twenty ninth aspect can include the system of any one of the first to twenty eighth aspects, wherein the at least one liquid separator comprises an immiscible liquid layer disposed on top of the liquid in the vessel.

A thirtieth aspect can include the system of any one of the first to twenty ninth aspects, where the vessel further comprises: a solid outlet, wherein the solid outlet is configured to pass a stream comprising a solid out of the vessel.

A thirty first aspect can include the system of the thirtieth aspect, wherein the solid outlet is fluidly coupled to a solids collection area in the vessel, where the vessel comprises a liquid recirculation loop, and wherein the solid collection area is above the liquid recirculation loop.

A thirty second aspect can include the system of the thirtieth or thirty first aspect, wherein the liquid recirculation loop comprises a physical barrier disposed within an upper portion of the vessel, wherein physical barrier divides an upper portion of the vessel below the upper liquid surface into a supply portion and the recirculation loop.

A thirty third aspect can include the system of any one of the first to thirty second aspects, wherein the vessel further comprises a supplemental gas inlet in an upper portion of the vessel.

A thirty fourth aspect can include the system of any one of the first to thirty third aspects, wherein the gas phase comprises hydrogen, wherein the solid phase comprises solid carbon, and wherein the liquid comprises at least one of a molten metal or a molten salt.

A thirty fifth aspect can include the system of any one of the first to thirty fourth aspects, wherein the liquid does not wet the solid phase in the vessel.

In a thirty sixth aspect, a process comprises: receiving a gas into a vessel, wherein the vessel contains a liquid; passing bubbles of the gas through the liquid, wherein a solid is present within the liquid; passing the gas out of an upper liquid surface at a top surface of the liquid; forming droplets of the liquid based on passing the gas out of the upper liquid surface, wherein the solid is separated from the liquid at the upper liquid surface; passing the gas and at least a portion of the solids out of the vessel through a gas outlet; and removing at least a portion of the droplets of the liquid before passing the gas and the solid out of the vessel.

A thirty seventh aspect can include the process of the thirty sixth aspect, wherein removing at least the portion of the droplets comprises: interrupting a breaking of the bubbles at the upper liquid surface.

A thirty eighth aspect can include the process of the thirty seventh aspect, wherein interrupting the breaking of the bubbles uses one or more solids disposed at the upper liquid surface within the liquid, wherein the one or more solids have a lower density that a density of the liquid, and wherein the one or more solids float on the liquid.

A thirty ninth aspect can include the process of any one of the thirty sixth to thirty eighth aspects, wherein removing at least the portion of the droplets comprises: passing the gas, the solid, and the droplets through or around a perforated plate disposed above the upper liquid surface; and removing at least the portion of the droplets based on contacting the droplets with the perforated plate.

A fortieth aspect can include the process of the thirty ninth aspect, wherein a surface of the perforated plate comprises a wetting material with respect to the liquid.

A forty first aspect can include the process of any one of the thirty sixth to fortieth aspects, wherein the vessel comprises an upper chamber having a widened upper portion, wherein the widened upper portion has a larger cross-sectional gas flow area than the cross-sectional flow area of the upper liquid surface, and wherein removing at least the portion of the droplets comprises: passing the gas, the solid, and the droplets through the widened upper portion; reducing the gas velocity through the widened upper portion based on the larger cross-sectional gas flow area; and allowing the droplets to settle in the widened upper portion prior to passing the gas and the solid out of the vessel through the gas outlet.

A forty second aspect can include the process of the forty first aspect, wherein a weir is disposed at or near the gas outlet within the widened upper portion, and wherein the process further comprises: collecting the solid at the weir upstream of the gas outlet.

A forty third aspect can include the process of any one of the thirty sixth to forty second aspects, wherein removing at least the portion of the droplets comprises: passing the gas, the solid, and the droplets through a packing material; contacting the droplets with the packing material; and passing the gas and the solids through the packing material with at least the portion of the droplets removed.

A forty fourth aspect can include the process of the forty third aspect, further comprising: forming a fluidized bed or a bubbling bed with the packing material based on passing the gas, the solid, and the droplets through the packing material; forming a stratified bed from the packing material, wherein a concentration of the liquid is higher in a lower portion of the stratified bed than a concentration in an upper portion of the stratified bed.

A forty fifth aspect can include the process of the forty third aspect, further comprising: forming a fluidized bed or a bubbling bed with the packing material based on passing the gas, the solid, and the droplets through the packing material; and forming a stratified bed from the packing material, wherein a concentration of the packing material is higher in a lower portion of the stratified bed than a concentration in an upper portion of the stratified bed.

A forty sixth aspect can include the process of the forty fifth aspect, wherein a concentration of the solid is higher in the upper portion of the stratified bed than a concentration in the lower portion of the stratified bed.

A forty seventh aspect can include the process of the forty fifth or forty sixth aspect, further comprising: milling the solid in the stratified bed based on a movement of the packing material within the stratified bed.

A forty eighth aspect can include the process of any one of the forty fourth to forty seventh aspects, wherein the vessel comprises a widened diameter portion that increases diameter from a bottom to a top of the packing material, and wherein the stratified bed is formed within the widened diameter portion.

A forty ninth aspect can include the process of any one of the forty third to forty eighth aspects, wherein the packing material comprises a wetting surface with respect to the liquid.

A fiftieth aspect can include the process of any one of the thirty sixth to forty seventh aspects, wherein removing at least the portion of the droplets comprises: passing the gas, the solid, and the droplets through a cyclonic separator disposed above the upper liquid surface; and removing at least the portion of the droplets in the cyclonic separator.

A fifty first aspect can include the process of any one of the thirty sixth to fiftieth aspects, wherein removing at least the portion of the droplets comprises: passing the gas, the solid, and the droplets through one or more trays arranged in a helical configuration; generating a cyclonic flow of the gas, the solid, and the droplets through the one or more trays; and removing at least the portion of the droplets in the one or more trays.

A fifty second aspect can include the process of any one of the thirty sixth to fifty first aspects, wherein removing at least the portion of the droplets comprises: passing the bubbles through one or more solid elements submerged in the liquid below the upper liquid surface; reducing a velocity of the bubbles rising through the liquid based on passing the bubbles through the one or more solid elements relative to a bubble rise velocity below the one or more solid elements; and preventing at least the portion of the droplets from forming based on reducing the velocity of the bubbles.

A fifty third aspect can include the process of any one of the thirty sixth to fifty second aspects, further comprising: passing the gas, the solid, and a remaining portion of the droplets through the gas outlet to a cyclonic separator, wherein the remaining portion of the droplets comprises the droplets with at least the portion of the droplets removed; separating an additional portion of the droplets in the cyclonic separator; and returning the separated additional portion of the droplets to the vessel.

A fifty fourth aspect can include the process of any one of the thirty sixth to fifty third aspects, further comprising: generating a swirling flow within the liquid; and coalescing the bubbles rising within the liquid based on the swirling flow.

A fifty fifth aspect can include the process of the fifty fourth aspect, wherein generating the swirling flow comprises: passing the bubble through a draft tube disposed in the liquid, wherein a flow within the draft tube has a swirling flow.

A fifty sixth aspect can include the process of the fifty fourth or fifty fifth aspect, wherein generating the swirling flow comprises injecting the bubbles into the draft tube at an angle configured to generate the swirling flow.

A fifty seventh aspect can include the process of any one of the fifty fourth to fifty sixth aspects, wherein generating the swirling flow comprises passing the bubbles through a deflector disposed within the draft tube, wherein the deflector has a helical surface.

A fifty eighth aspect can include the process of any one of the thirty sixth to fifty seventh aspects, wherein the vessel comprises: a headspace above the upper liquid surface, wherein a cross-sectional flow area in the headspace is greater than a cross sectional area of the upper liquid surface; a first outlet point, wherein a cross sectional flow area of the first outlet point is less than the cross-sectional flow area in the headspace; a liquid return line fluidly coupling the first outlet point with the liquid in the vessel; and a transport section fluidly coupling the first outlet point to the gas outlet.

A fifty ninth aspect can include the process of the fifty eighth aspect, wherein a fluid pump is fluidly coupled with a lower portion of the liquid and the transport section, and wherein the process further comprises: passing a portion of the liquid from the lower portion of the liquid to the transport section; and exchanging heat with the portion of the liquid and the gas phase passing through the transport section to the gas outlet.

A sixtieth aspect can include the process of any one of the thirty sixth to fifty ninth aspects, wherein the vessel comprises a narrowed section above the upper liquid surface, wherein the narrowed section is disposed between the upper liquid surface and the gas outlet, and wherein removing at least the portion of the droplets comprises: coalescing the bubbles above the upper liquid surface; and removing at least the portion of the droplets in the coalesced bubbles above the upper liquid surface.

A sixty first aspect can include the process of any one of the thirty sixth to sixtieth aspects, wherein an immiscible liquid layer is disposed on top of the liquid in the vessel, and wherein removing at least the portion of the droplets comprises: passing the gas, the solid, and the droplets through the immiscible liquid layer; and capturing at least the portion of the droplets in the immiscible liquid layer.

A sixty second aspect can include the process of any one of the thirty sixth to sixty first aspects, further comprising: removing the solids from the vessel through a solids outlet, wherein the solids removed from the vessel are separate from the gas and at least the portion of the solids.

A sixty third aspect can include the process of the sixty second aspect, wherein the solid outlet is fluidly coupled to a solids collection area in the vessel, where the vessel comprises a liquid recirculation loop, and wherein the solid collection area is above the liquid recirculation loop.

A sixty fourth aspect can include the process of the sixty second or sixth third aspect, wherein the liquid recirculation loop comprises a physical barrier disposed within an upper portion of the vessel, wherein physical barrier divides an upper portion of the vessel below the upper liquid surface into a supply portion and the recirculation loop.

A sixty fifth aspect can include the process of any one of the thirty sixth to sixty fourth aspects, wherein the vessel further comprises a supplemental gas inlet in an upper portion of the vessel, and wherein the process further comprises: injecting a supplemental gas stream into the vessel above the upper liquid level; and entraining the solids in the gas using the supplemental gas stream.

A sixty sixth aspect can include the process of any one of the thirty sixth to sixty fifth aspects, wherein the gas comprises hydrogen, wherein the solid comprises solid carbon, and wherein the liquid comprises at least one of a molten metal or a molten salt.

A sixty seventh aspect can include the process of any one of the thirty sixth to sixty sixth aspects, wherein the liquid does not wet the solid in the vessel.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. A system comprising:
a vessel having a gas inlet and a gas outlet;
a liquid within the vessel, wherein the liquid comprises an upper liquid surface within the vessel;
a solid phase and a gas phase present within the vessel; and
at least one liquid separator disposed within the vessel, wherein the liquid separator is configured to remove at least a portion of liquid droplets generated based on the gas phase and the solid phase passing through the liquid.

2. The system of claim 1, wherein the at least one liquid separator comprises:
one or more solids disposed at the upper liquid surface within the liquid, and wherein the one or more solids have a lower density than a density of the liquid, and wherein the one or more solids float on the liquid.

3-4. (canceled)

5. The system of claim 1, where the at least one liquid separator comprises:
a perforated plate disposed above the upper liquid surface, where the perforated plate is disposed between the upper liquid surface and the gas outlet, and wherein the gas phase and the solid phase are configured to pass through or around the perforated plate before passing out the gas outlet, wherein a surface of the perforated plate comprises a wetting material with respect to the liquid.

6. (canceled)

7. The system of claim 1, wherein the at least one liquid separator comprises a widened upper chamber within the vessel, wherein the widened upper portion has a larger cross-sectional gas flow area than the cross-sectional flow area of the upper liquid surface.

8. The system of claim 7, wherein the at least one liquid separator further comprises a weir disposed at or near the gas outlet within the widened upper chamber, wherein the weir is configured to collect the solid phase upstream of the gas outlet.

9. The system of claim 1, wherein the at least one liquid separator comprises a packing material disposed above the upper liquid surface, and wherein a surface of the packing comprises a wetting material with respect to the liquid.

10. The system of claim 9, wherein the packing material comprises a packed bed supported above the upper liquid surface, or wherein the packing material comprises a fluidized bed or a bubbling bed above the upper liquid surface.

11-13. (canceled)

14. The system of claim 1, wherein the at least one liquid separator comprises a cyclonic separator disposed in an upper portion of the vessel between the upper liquid surface and the gas outlet, wherein the cyclonic separator is configured to remove at least the portion of liquid droplets generated based on the gas phase and the solid phase passing through the liquid using centrifugal force.

15. The system of claim 1, wherein the at least one liquid separator comprises one or more trays arranged in a helical configuration, wherein the one or more trays are disposed above the upper liquid surface and the gas outlet, wherein the one or more trays are configured to form a helical path for the gas phase above the upper liquid surface.

16-21. (canceled)

22. The system of claim 1, wherein the at least one liquid separator comprises:
a draft tube disposed within the liquid, wherein the gas inlet and the draft tube are configured to contain bubbles of the gas phase rising from the gas inlet through the liquid.

23. The system of claim 22, wherein the draft tube is further configured to generate a helical flow of the liquid within the draft tube and force the bubbles to the center of the draft tube.

24. The system of claim 22, further comprising a deflector disposed below the draft tube, wherein the deflector is configured to pass the bubbles in a tangential direction within the draft tube.

25-28. (canceled)

29. The system of claim 1, wherein the at least one liquid separator comprises an immiscible liquid layer disposed on top of the liquid in the vessel.

30. The system of claim 1, where the vessel further comprises:
a solid outlet, wherein the solid outlet is configured to pass a stream comprising a solid out of the vessel, and wherein the solid outlet is fluidly coupled to a solids collection area in the vessel, where the vessel comprises a liquid recirculation loop, and wherein the solid collection area is above the liquid recirculation loop.

31-35. (canceled)

36. A process comprising:
receiving a gas into a vessel, wherein the vessel contains a liquid;
passing bubbles of the gas through the liquid, wherein a solid is present within the liquid;
passing the gas out of an upper liquid surface at a top surface of the liquid;
forming droplets of the liquid based on passing the gas out of the upper liquid surface, wherein the solid is separated from the liquid at the upper liquid surface;
passing the gas and at least a portion of the solids out of the vessel through a gas outlet; and
removing at least a portion of the droplets of the liquid before passing the gas and the solid out of the vessel.

37. The process of claim 36, wherein removing at least the portion of the droplets comprises:
interrupting a breaking of the bubbles at the upper liquid surface, and wherein interrupting the breaking of the bubbles uses one or more solids disposed at the upper liquid surface within the liquid, wherein the one or more solids have a lower density that a density of the liquid, and wherein the one or more solids float on the liquid.

38. (canceled)

39. The process of claim 36, wherein removing at least the portion of the droplets comprises:
passing the gas, the solid, and the droplets through or around a perforated plate disposed above the upper liquid surface; and
removing at least the portion of the droplets based on contacting the droplets with the perforated plate.

40. (canceled)

41. The process of claim 36, wherein the vessel comprises an upper chamber having a widened upper portion, wherein the widened upper portion has a larger cross-sectional gas flow area than the cross-sectional flow area of the upper liquid surface, and wherein removing at least the portion of the droplets comprises:
passing the gas, the solid, and the droplets through the widened upper portion;
reducing the gas velocity through the widened upper portion based on the larger cross-sectional gas flow area; and
allowing the droplets to settle in the widened upper portion prior to passing the gas and the solid out of the vessel through the gas outlet.

42. (canceled)

43. The process of claim 36, wherein removing at least the portion of the droplets comprises:
passing the gas, the solid, and the droplets through a packing material;
contacting the droplets with the packing material; and
passing the gas and the solids through the packing material with at least the portion of the droplets removed:
forming a fluidized bed or a bubbling bed with the packing material based on passing the gas, the solid, and the droplets through the packing material; and
forming a stratified bed from the packing material, wherein a concentration of the liquid is higher in a lower portion of the stratified bed than a concentration in an upper portion of the stratified bed.

44-65. (canceled)

66. The process of claim 36, wherein the gas comprises hydrogen, wherein the solid comprises solid carbon, and wherein the liquid comprises at least one of a molten metal or a molten salt.

67. (canceled)
